(19) United States
(12) Patent Application Publication
(10) Pub. No.: US 2026/0295386 A1
(43) Pub. Date: Oct. 1, 2026

(54) METHOD FOR REAL-TIME SPATIAL HAPTIC RENDERING VIA DYNAMIC PRIORITY MANAGEMENT AND DISTANCE-BASED OBJECT CULLING USING INTELLIGENT HAPTIC SIGNAL MEDIATION

(71) Applicant: Nokia Technologies Oy, Espoo (FI)

(72) Inventors: Devbrat ANURAGI, Tampere (FI); Ahmed FAROOQ, Tampere (FI); Roope RAISAMO, Tampere (FI); Patrick COE, Tampere (FI); Kashyap KAMMACHI SREEDHAR, Tampere (FI); Saba AHSAN, Espoo (FI)

(21) Appl. No.: 19/578,572

(22) Filed: Mar. 25, 2026

Related U.S. Application Data
(60) Provisional application No. 63/778,657, filed on Mar. 27, 2025.

(51) Int. Cl. A63F 13/285; A63F 13/5372; A63F 13/60

(52) U.S. Cl. CPC A63F 13/285; A63F 13/5372; A63F 13/60

(57) ABSTRACT

Methods and apparatuses provide a robust, efficient, and adaptable foundation for haptic rendering. The method includes obtaining a user's haptic interaction point and processing initial haptic data object(s) by retrieving an initial haptic data object from a priority queue and determining a distance between the user's haptic interaction point and the initial haptic data object. In an instance in which the distance is outside of a dynamic sphere of influence for the initial haptic data object or in which the distance is increasing at a rate greater than a threshold rate, the haptic object is culled. In an instance where the distance is within the dynamic sphere of influence for the initial haptic data object, a priority score of the initial haptic data object is updated with an updated priority score and updated in the priority queue. The method further includes generating a user representation for an updated scene.

### CROSS-REFERENCE TO RELATED APPLICATIONS

This application claims the benefit of U.S. Provisional Application No. 63/778,657, filed Mar. 27, 2025, the entire contents of which are incorporated herein by reference.

### TECHNICAL FIELD

Various example embodiments relate generally to real-time interactive applications (VR/AR games) and, more particularly, to haptic rendering technology.

### BACKGROUND

Current haptic rendering technology in real-time interactive applications (VR/AR, games) faces significant computational challenges when dealing with complex environments containing numerous haptic objects. The core technical problem stems from the following drawbacks of existing approaches such as naive haptic rendering is inefficient, unnecessary calculations, high CPU/GPU load, lack of dynamic prioritization, equal treatment of unequal objects, poor responsiveness to changing conditions, cognitive overload (potential), inefficient data structures, and static interaction regions.

### BRIEF SUMMARY

According to some aspects, there is provided the subject matter of the independent claims. Some further aspects are defined in the dependent claims.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 depicts a scene description reference architecture in accordance with one or more embodiments of the present disclosure;

FIG. 2 depicts a grid of taxels, mapping pixels to different haptic textures in accordance with one or more embodiments of the present disclosure;

FIG. 3 depicts an example of glTF scene using MPEG_haptic and MPEG_haptic_material extensions in accordance with one or more embodiments of the present disclosure;

FIG. 4 depicts a processing model for the activation of a single trigger in accordance with one or more embodiments of the present disclosure;

FIG. 5 depicts a processing model when a new scene description update is received in accordance with one or more embodiments of the present disclosure;

FIG. 6 depicts haptic media functions in the user plane architecture for split management architecture in accordance with one or more embodiments of the present disclosure;

FIG. 7 depicts haptic media entities in the XR baseline client architecture in accordance with one or more embodiments of the present disclosure;

FIG. 8 is a block diagram of an apparatus configured in accordance with one or more example embodiments of the present disclosure;

FIG. 9 is a flowchart depicting a method in accordance with one or more example embodiments of the present disclosure;

FIG. 10 is a flowchart depicting a method in accordance with one or more example embodiments of the present disclosure;

FIG. 11 is a flowchart depicting a method in accordance with one or more example embodiments of the present disclosure;

FIG. 12 depicts the priority queue architecture in accordance with one or more example embodiments of the present disclosure;

FIG. 13 depicts a sphere of influence in accordance with one or more example embodiments of the present disclosure;

FIG. 14 depicts a dynamic sphere of influence in accordance with one or more example embodiments of the present disclosure;

FIG. 15 depicts a first point in time for a real-time haptic rending system that prioritizes haptic feedback based on a dynamic sphere of influence around the user in accordance with one or more example embodiments of the present disclosure;

FIG. 16 depicts a second point in time for a real-time haptic rending system that prioritizes haptic feedback based on a dynamic sphere of influence around the user in accordance with one or more example embodiments of the present disclosure;

FIG. 17 is a flowchart depicting a method in accordance with one or more example embodiments of the present disclosure; and

FIG. 18 illustrates another flowchart illustrating a method, such as by the apparatus of FIG. 8, in accordance with one or more other example embodiments of the present disclosure;

FIG. 19 illustrates another flowchart illustrating a method, such as by the apparatus of FIG. 8, in accordance with one or more other example embodiments of the present disclosure;

FIG. 20 illustrates another flowchart illustrating a method, such as by the apparatus of FIG. 8, in accordance with one or more other example embodiments of the present disclosure;

FIG. 21 illustrates another flowchart illustrating a method, such as by the apparatus of FIG. 8, in accordance with one or more other example embodiments of the present disclosure; and

FIG. 22 illustrates another flowchart illustrating a method, such as by the apparatus of FIG. 8, in accordance with one or more other example embodiments of the present disclosure.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It is to be understood that although the terms “first,” “second” and the like may be used herein to describe various elements, these elements should not be limited by these terms. These terms are only used to distinguish one element from another.

As used herein, the terms “data,” “content,” “information,” and similar terms may be used interchangeably to refer to data capable of being transmitted, received and/or stored in accordance with an embodiment of the present disclosure. Thus, use of any such terms should not be taken to limit the spirit and scope of one or more embodiments of the present disclosure.

Haptics provide an additional layer of entertainment and sensory immersion to the user. Therefore, the user experience and enjoyment of media content, from a ISOBMFF files, broadcast channel, streaming games or mobile advertisements can be significantly enhanced by the judicious addition of haptics to the audio/video content. To that end, haptics has been proposed as a first-order media type, akin to audio and video, in ISOBMFF. Further, haptics has also been proposed as an addition to the ISO/IEC 23009-1:2019 (MPEG-DASH) standard to signal the presence of haptics in MP4 segments to DASH streaming clients. Lastly, the ISO/IEC 23090 (MPEG-I) use cases have been augmented with haptics

Haptics digital encoding is the storing of tactile data in a digital format. As with audio and video, digital encoding is of fundamental importance to allow digital haptic devices to function. Haptics encoding gained relevance with the increased market importance of wideband haptics in consumer peripherals such as smartphones with haptic engines and game consoles with haptic enabled controllers. The prior generation of haptics peripherals was based on less expressive haptic actuators usually based on state machine control processes.

In the field of haptics, the signal encoding usually takes one of two approaches such as quantized and descriptive. Quantized is generally made from measured data. The samples from the original phenomenon are stored at a specific acquisition frequency inside the file to represent this signal. One example of a quantized haptic signal is proposed through WAV files, originally developed for audio. WAV file formalism allows the capture of real-world data and the representation of complex wideband haptic feedback. This type of haptics encoding has the disadvantage of being difficult to modify once encoded due to the inability to access the primitives used to create the signal. Descriptive is used to encode haptic signals as a combination of functions to be synthesized. Examples of such vectorized formats include AHAP and IVS. These formats have the advantage of being created with a composition of primitives. They are easily modifiable at runtime by an application and by dedicated editing tools. Currently, these solutions support only vibrotactile perception but can easily be extended for other forms of haptics such as kinesthetic, temperature and textures. They also tend to be memory inefficient with increasing signal complexity and cannot encode non-periodic phenomena.

The scene description is consumed by a Presentation Engine to render a 3D scene to the viewer. The Presentation Engine allows for the creation of immersive experiences using timed media. The scene description extensions are designed with the goal of decoupling the Presentation Engine from the Media Access Function. Presentation Engine and Media Access Function communicate through the Media Access Function API, which allows the Presentation Engine to request timed media required for the rendering of the scene. The Media Access Function will retrieve the requested timed media and make it available in a timely manner and in a format that can be immediately processed by the Presentation Engine. For instance, a requested timed media asset may be compressed and residing in the network, so the Media Access Function will retrieve and decode the asset and pass the resulting decoded media data to the Presentation Engine for rendering. The decoded media data is passed in form of buffers from the Media Access Function to the Presentation Engine. The requests for timed media are passed through the Media Access Function API from the Presentation Engine to the Media Access Function.

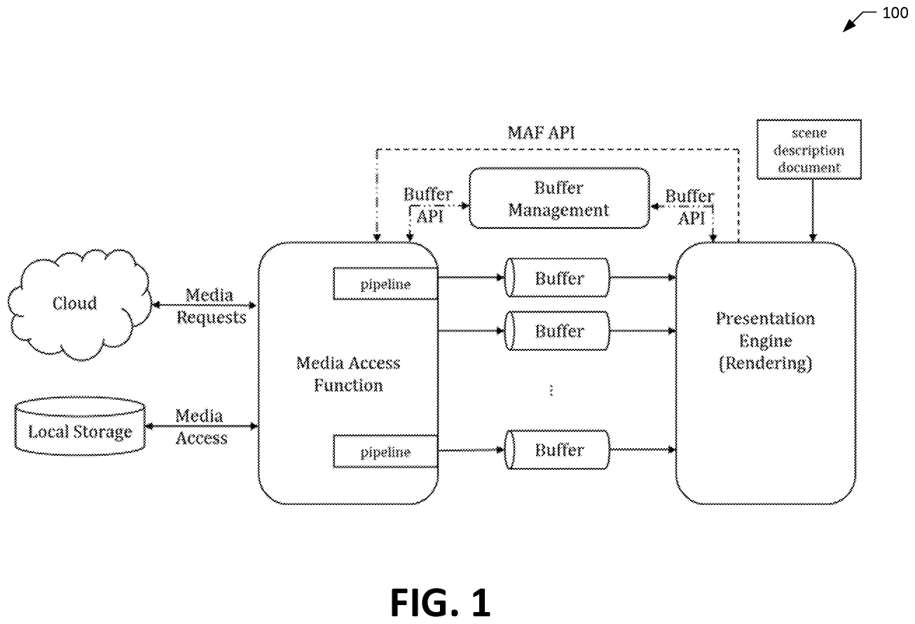

FIG. 1 depicts a scene description reference architecture 100. In various embodiments, the corresponding procedures are described as follows: the Presentation Engine receives and parses the scene description document and following scene description updates. The Presentation Engine identifies timed media that needs to be presented and identifies the required presentation time. The Presentation Engine then uses the MAF API to request the media and provides the following information including but not limited to, where the MAF can find the requested media, what parts of the media and at what level of detail, when the requested media has to be made available, and in which format the Presentation Engine wants the data and how it is passed to the Presentation Engine. In various embodiments, the MAF instantiates the media fetching and decoding pipeline for the requested media at the appropriate time. The MAF ensures that the requested media is available at the appropriate time in the appropriate buffers for access by the Presentation Engine. Furthermore, the MAF ensures that the media is decoded and reformatted to match the expected format by the Presentation Engine as described by the scene description document. The MPEG_haptic and MPEG_haptic_material extensions provide the ability to define the integration of haptics in a glTF scene. For example, in MPEG_haptic, the extensions are defined at the glTF file level. The extension contains an array defining every haptic object. In the case of MPEG_haptic_material, the extension contains an array defining all texture-based haptic data at the glTF file level. At the mesh level, the extension contains a single reference to the array of the same extension at the glTF file level.

Haptic signals may be used in a variety of use cases, some of which are defined in Table 1.

TABLE 1
Use Cases for Haptic Signals.

| Use Case | Haptic Data | Rendering behavior |
|---|---|---|
| Touch the surface of a wall | A Texture perception is | Upon collision between a |
| and feel a texture | defined describing a surface | body part and the textured |
| | friction pattern. | wall, the Texture track of the |
| | | media is read based on the |
| | | displacement of the body part |
| | | on the surface. |
| Press a button to get stiffness | A Stiffness/force feedback | When the button is pressed, |
| feedback | perception is defined | the force profile curve is read |
| | describing a force curve | based on the pressure depth |
| | profile. | of the button. |
| Opening a door and feeling | A Texture perception is | When the door is moving, the |
| friction of the door with the | defined describing a surface | Texture track of the media is |
| floor | friction pattern. | read based on the |
| | | displacement of the door |
| | | (rotation angle converted to |
| | | distance traveled). |
| Walking in a street and at | Localized vibrations are | Upon time event “rain starts” |
| some time rain is falling on | defined to simulate raindrop | vibrations patterns are |
| the user body | | synthesized and rendered on |
| | | the appropriate device. |

The MPEG_haptic extension allows the support of haptic data as defined in ISO/IEC 23090-31. The MPEG_haptic extension allows for an independent haptic media like an audio content or an image. This extension is attached at the glTF file level and stores the haptic data contained in the scene. The MPEG_haptic extension contains an array of haptic objects as detailed in Table 2 below. The data for each element of the array is detailed for one embodiment in Table 3 below, which contains a list of accessors to media in the MPEG_media extension.

TABLE 2
Semantic description of the MPEG_haptic extension at the glTF file level

| Name | Type | Default | Description |
|---|---|---|---|
| haptic | Array<MPEG_ | N/A | Provides a list of haptic elements at |
| Objects | Haptics. | | the glTF file level to enable haptic |
| | hapticObject> | | support |

TABLE 3
Semantic description of the MPEG_haptics.hapticObject items of the
hapticObjects array from the MPEG_haptic extension

| Name | Type | Default | Description |
|---|---|---|---|
| accessors | array | N/A | Array of accessors to one or more |
| | <integer> | | media sources in MPEG media.media |
| | | | array containing haptic media files. |

The data referenced by the accessors is stored in dedicated Haptic buffers. The Haptic buffer formats correspond to the HMPG binary format detailed in ISO/IEC 23090-31.

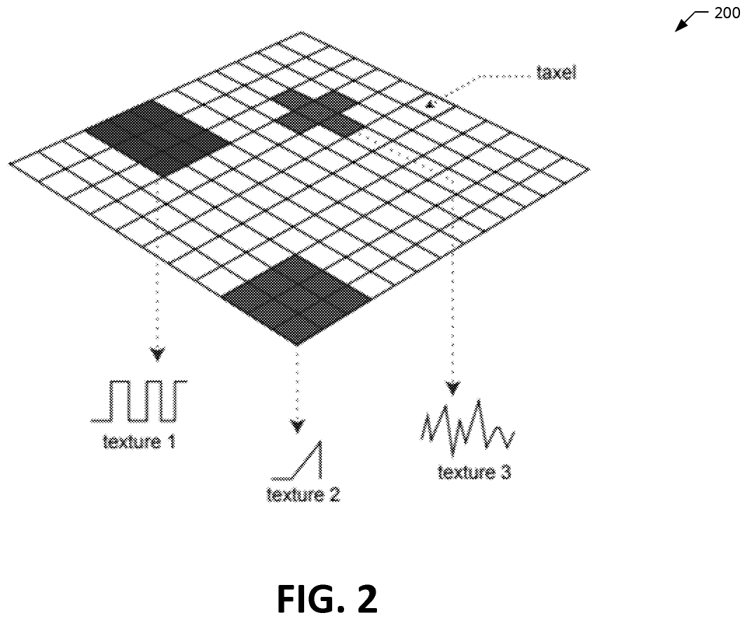

The MPEG_haptic_material extension defines the association of haptic media with the interactivity extension. The haptic texture associated with a 3D object does not contain RGB values but haptic values. These values are exploited directly by the haptic renderer. The extension also uses the concept of taxels. Each pixel of the texture can be mapped to a distinct spatial (or temporal) signal as illustrated in FIG. 2.

FIG. 2 depicts a grid of taxels 200, mapping pixels to different haptic textures in accordance with one or more embodiments of the present disclosure. An array of textures for each haptic property is used. A haptic texture can be provided both as a traditional 2D texture and as a taxel map in the same file, giving the possibility to the rendering engine to choose the most appropriate. Additional information is added to each element of the haptic texture arrays for the rendering engine to adequately interpret a texture. Each array element then contains a haptic texture and a texture type expressed as an Enumeration. Possible values of the enumeration are HIGH_RESOLUTION (the haptic texture is a high resolution 2D texture directly storing haptic values), LOW_RESOLUTION (the haptic texture is a low resolution 2D texture directly storing haptic values), REFERENC (the haptic texture is a 2D taxel map containing references to haptic signals. Each pixel of the texture corresponds to an index in the accessors array of the haptic object of the MPEG_haptic extension that is associated to the node), and OTHER (unknown proprietary texture format)

To interpret the data contained in 2D textures, the bit depth and range of these textures are specified according to tables 4 and 5.

TABLE 4
bit depth and range values for each haptic property for
low resolution haptic textures

| Haptic map | Format | Range | Resolution |
|---|---|---|---|
| stiffness | 8-bit | 0-10000 N · s −1/ | 40 N · s −1/ |
| | | m · s −1 | m · s −1 |
| friction | 8-bit | ±5 | 0.04 |
| vibrotactileTexture | 8-bit | ±10 | 0.08 |
| temperature | 8-bit | [−50:+75]° C. | 0.5° C. |
| vibration | 8-bit | [0-1] | 0.004 |
| custom | 8-bit | 0-255 | 1 |

TABLE 5
bit depth and range values for each haptic property for high
resolution haptic textures

| Haptic map | Format | Range | Resolution |
|---|---|---|---|
| stiffness | 16-bit | 0-10000 | 0.15 |
| | | N · s −1/m · s −1 | N · s −1 /m · s −1 |
| friction | 16-bit | ±100 | 0.003 |
| vibrotactile | 16-bit | ±100 | 0.0015 |
| Texture | | | |
| temperature | 16-bit | [−100:+150]° C. | 0.004° C. |
| vibration | 8-bit (amplitude) | [0-1] | 0.004 |
| | 8-bit (frequency) | [0-300] Hz | 1.17 Hz |
| custom | 16-bit | 0-65535 | 1 |

For the high-resolution texture, values of each texture map pixel are divided in two bytes: the first byte contains the magnitude value and the second byte contains the frequency.

As detailed in Table 5, at the glTF file level, the MPEG_haptic_material extension contains an array of haptic materials. The data for each element of the array is detailed in Table 6, which contains multiple lists of textures (each combined with an enumeration) associated to different haptic properties.

TABLE 6
Semantic description of the MPEG_haptic_material extension at the glTF file
level

| Name | Type | Default | Description |
|---|---|---|---|
| materials | Array<MPEG_haptic_material. | N/A | Provides a list of haptic materials at the |
| | material> | | glTF file level to enable haptic support. |

The following table, Table 7A, describes the list of haptic properties of the extension:

TABLE 7A
Semantic description of the MPEG_haptics_material material items of the
materials array from the glTF file level MPEG_haptic_material extension

| Name | Type | Default | Description |
|---|---|---|---|
| haptic | integer | N/A | Index to an element of the hapticObjects array |
| | | | of the MPEG_haptic extension. This is used |
| | | | for “Reference” textures to access the haptic |
| | | | information. |
| stiffness | array<enumeration, | NULL | It determines the perceived stiffness of a |
| | textureInfo> | | surface. Which means the force perceived by |
| | | | the user opposed to the normal penetration of |
| | | | a material by a body part. |
| | | | It is described with a texture storing the |
| | | | stiffness coefficients. The suggested |
| | | | rendering model is: |
| | | | F = kx where k is the value of stiffness for the |
| | | | displacement x along the asset stiffness |
| | | | function. This model is valid for an isotropic |
| | | | material. |
| friction | array<enumeration, | NULL | It indicates the perceived friction, which is a |
| | textureInfo> | | force opposing the movement of a body part |
| | | | sliding on a surface. |
| | | | It is described with a texture storing the |
| | | | coefficient of friction. |
| | | | The suggested rendering model is: |
| | | | F_f = mu * Fn where mu is the coefficient of |
| | | | friction, and Fn is the normal applied force by |
| | | | the body part on the surface. |
| vibrotactile | array<enumeration, | NULL | It indicates the perceived texture by a body |
| Texture | textureInfo> | | part while sliding on a surface. |
| temperature | array<enumeration, | NULL | It indicates the perceived temperature of an |
| | textureInfo> | | object. |
| | | | It is described with a texture storing the |
| | | | temperature distribution. |
| vibration | array<enumeration, | NULL | It indicates a vibration signal. |
| | textureInfo> | | It is described with a texture storing the |
| | | | amplitude and/or frequency of the signal. |
| custom | array<enumeration, | NULL | Texture containing custom haptic data. |
| | textureInfo> | | |

As detailed in Table 7B at the mesh level, the MPEG_haptic_material extension contains a single reference to an element of the materials array detailed in Table 5.

TABLE 7B
description of the MPEG_Haptic_material extension at the mesh level

| Name | Type | Default | Description |
|---|---|---|---|
| hapticMaterial | Integer | N/A | Reference to an item in the materials |
| Index | | | array of the MPEG_haptic_material |
| | | | extension defined at glTF file level |

When a scene description file becomes available, the Presentation Engine parses the related glTF file, detects if the MPEG_haptic and MPEG_haptic_material extension is used, identifies nodes associated with haptics by analyzing the haptic actions defined in the interactivity extension, and identifies haptic media in the MPEG_media extension where the autoplay property is set to true or the startTime property is defined. At runtime the presentation engine renders the identified haptic media based on the autoplay or startTime property. When behaviors launch a haptic action following the trigger activation, the presentation engine retrieves the haptic data specified in the associated haptic object through the MAF API. The presentation engine then renders the data based on the properties specified in the associated haptic action.

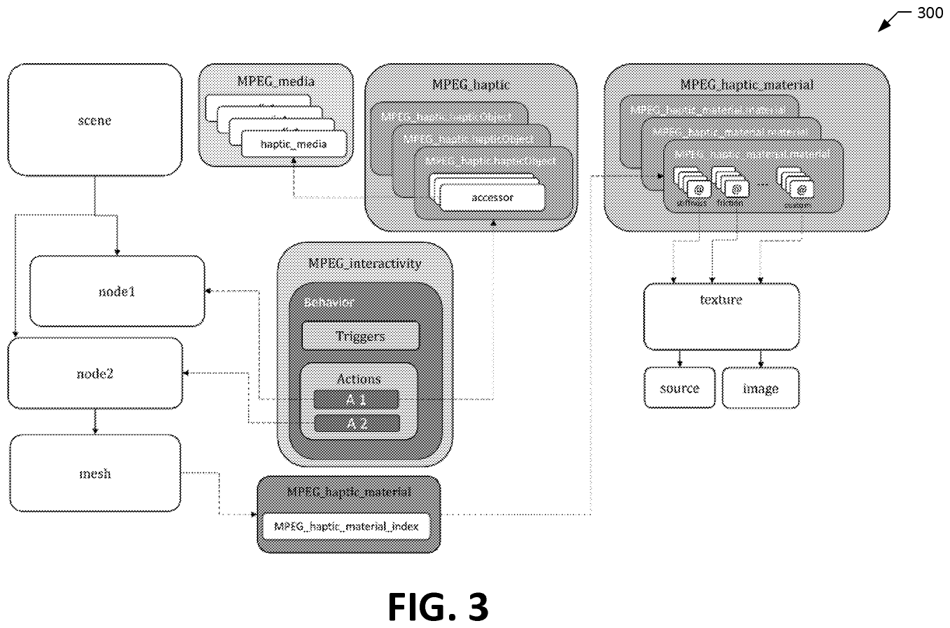

FIG. 3 provides a simplified example of a glTF scene 300 combining the interactivity and haptics extensions. Haptic information is stored at the glTF file level with the MPEG_haptic and MPEG_haptic_material extensions.

The relation between a node in the scene and haptic data from the MPEG_haptic extension is established in the MPEG_interactivity extension through haptic actions. Interactive haptic feedback is produced by defining behaviors with triggers (e.g., collisions, proximity, etc.) and haptic actions. For each node in a haptic action, the associated Haptic data is defined either through a reference to an element of the MPEG_Haptic extension (action A1 and node1 in FIG. 3) or through a MPEG_haptic_material attached to a mesh of the node (action A2 and node2 in FIG. 3). When a haptic action is triggered, the associated haptic data is rendered according to the properties specified in the action. Table 8 contains examples of how haptics would be driven by spatial displacement actions and additional parameters to tune the haptic rendering in an example embodiment.

TABLE 8
Haptic Actions Driven by Actions and Additional Parameters

| | | Override haptic |
|---|---|---|
| Action | Default haptic behavior | parameters |
| None | N/A | N/A |
| Free | Read Texture based on distance | Rescale the haptics |
| movement | traveled in space | rendering independent |
| | | variable by an arbitrary |
| | | length. |
| Free | Read Texture based on distance | Rescale the haptics |
| position, | traveled in space | rendering independent |
| fix rotation | | variable by an arbitrary |
| | | length. |
| Free | Read Texture based on distance | Rescale the haptics |
| position, | traveled in space | rendering independent |
| pivot | | variable by an arbitrary |
| rotation | | length. |
| Sliding | Read Texture based on slider | Rescale the haptics |
| | displacement distance as input. | rendering independent |
| | | variable by an arbitrary |
| | | length. |
| Rotation | Read Texture based on distance | Rescale the haptics |
| around | traveled during the rotation. | rendering independent |
| pivot | | variable by an arbitrary |
| | | length. |
| Button | Read force feedback curve based | Rescale the haptics |
| | on the current depth of the | rendering independent |
| | button. | variable by an arbitrary |
| | | length. |

Spatial displacement does not need to drive time-based haptic feedback (such as vibrations). Interactivity is supported at the scene level and at the node level through the definition of two extensions MPEG_scene_interactivity and MPEG_node_interactivity. When present, the MPEG_scene_interactivity extension is included as extension to the scene object. When present, the MPEG_node_interactivity extension is included as extension to anode object. The MPEG_node_interactivity extension is used to complement the interactivity extension defined at the scene level. One particular case is the definition of the parameters for a physics engine. That is, when an MPEG_node_interactivity extension contains a trigger of type TRIGGER_COLLISION without being referenced by a trigger of type TRIGGER_COLLISION at the MPEG_scene_interactivity extension, this node is not considered for collision detection and instead only be used by the physics engine. The semantic of the MPEG_scene_interactivity extension is based on the definition of trigger, action and behavior objects as shown in Table 9.

TABLE 9
Definition of Trigger, Action, and Behavior Objects

| Name | Type | Usage | Default | Description |
|---|---|---|---|---|
| triggers | array | M | | Contains the definition of all |
| | | | | the triggers used in that scene. |
| actions | array | M | | Contains the definition of all |
| | | | | the actions used in that scene. |
| behaviors | array | M | | Contains the definition of all |
| | | | | the behaviors used in that |
| | | | | scene. A behavior is |
| | | | | composed of a pair of |
| | | | | (triggers, actions), control |
| | | | | parameters of triggers and |
| | | | | actions, a priority weight |
| | | | | and an optional interrupt |
| | | | | action. |
| recommended | Boolean | O | false | Determines whether the |
| Physics | | | | application should enable a |
| HighPrecision | | | | more deterministic and |
| | | | | precise physic simulation |
| gravity | Number | O | −9.81 | Determine the gravity for the |
| | | | | whole scene. In meter per |
| | | | | second square (m · s⁻²) as |
| | | | | defined in the international |
| | | | | unit system. |
| recommended | Number | O | 50 | Provides the recommended |
| Physics | | | | frame rate at which the |
| FrameRate | | | | Physics Engine should |
| | | | | operate. In frame per second |
| | | | | as defined in the international |
| | | | | unit system. |
| bounce | number | O | 1 | A contact with a relative |
| Threshold | | | | velocity below this threshold |
| | | | | will not result in a bounce. |
| | | | | In meter per second (m · s⁻¹) |
| | | | | as defined in the international |
| | | | | unit system. |

The semantic of a trigger is provided in Table 10 and the types of triggers are provided in Table 11.

TABLE 10
Semantic of a trigger

| Name | Type | Usage | Default | Description |
|---|---|---|---|---|
| type | enumeration | M | | An element that |
| | | | | defines the type of the |
| | | | | trigger. |
| if (type == | | | | |
| TRIGGER_COLLISION){ | | | | |
| nodes | array | M | | Indices of the nodes in |
| | | | | the nodes array to be |
| | | | | considered for |
| | | | | collision |
| | | | | determination. Any |
| | | | | detection of collision |
| | | | | activates the trigger |
| primitives | array | O | N/A | List of primitives used |
| | (Primitive) | | | to activate the |
| | | | | proximity or collision |
| | | | | trigger. |
| } | | | | |
| if (type == | | | | |
| TRIGGER_PROXIMITY){ | | | | |
| referenceNode | number | O | N/A | Index in the nodes |
| | | | | array, of the node to |
| | | | | consider for the |
| | | | | proximity evaluation. |
| | | | | In the absence of the |
| | | | | referenceNode |
| | | | | attribute, the active |
| | | | | camera managed by |
| | | | | the application is used. |
| distanceLowerLimit | number | O | 0 | Threshold minimum in |
| | | | | meters for the |
| | | | | proximity calculation, |
| | | | | based on the distance |
| | | | | between the nodes and |
| | | | | the referenceNode. |
| distanceUpperLimit | number | M | | Threshold maximum |
| | | | | in meters for the |
| | | | | proximity calculation, |
| | | | | based on the distance |
| | | | | between the nodes and |
| | | | | the referenceNode. |
| nodes | array | M | | Indices of the nodes in |
| | | | | the nodes array to be |
| | | | | considered. All the |
| | | | | nodes have a distance |
| | | | | from the origin of their |
| | | | | local space to |
| | | | | the referenceNode |
| | | | | above the |
| | | | | distanceLowerLimit |
| | | | | and below the |
| | | | | distance UpperLimit to |
| | | | | activate the trigger |
| primitives | array | O | N/A | List of primitives used |
| | (Primitive) | | | to activate the |
| | | | | proximity or collision |
| | | | | trigger. |
| } | | | | |
| if (type == | | | | |
| TRIGGER_USER_INPUT){ | | | | |
| userInputDescription | string | M | | Describes the user |
| | | | | body part and gesture |
| | | | | related to the input. |
| | | | | The format follows the |
| | | | | OpenXR input path |
| | | | | description as defined |
| | | | | in [OpenXR] section |
| | | | | 6. An example is: |
| | | | | “/user/hand/left/grip” |
| nodes | array | O | N/A | Indices of the nodes in |
| | | | | the nodes array to be |
| | | | | considered for this |
| | | | | user input. |
| } | | | | |
| if (type== | | | | |
| TRIGGER_VISIBILITY){ | | | | |
| cameraNode | number | M | | Index to the node |
| | | | | containing a camera in |
| | | | | the nodes array for |
| | | | | which the visibilities |
| | | | | are determined. |
| | | | | The visibility trigger is |
| | | | | evaluated only if the |
| | | | | related camera is |
| | | | | active. |
| nodes | array | M | | Indices of the nodes in |
| | | | | the nodes array to be |
| | | | | considered. All the |
| | | | | nodes are visible to the |
| | | | | camera to activate the |
| | | | | trigger. |
| } | | | | |

TABLE 11
Type of Trigger

| Trigger type | Description |
|---|---|
| TRIGGER_COLLISION = 0 | Collision Trigger |
| TRIGGER_PROXIMITY | Proximity Trigger |
| TRIGGER_USER_INPUT | User Input Trigger |
| TRIGGER_VISIBILITY | Visibility Trigger |

The semantics of MPEG_scene_interactive.trigger.primitive properties are provided in Table 12 and the semantical description of the each of the primitive regions is provided in Table 13

TABLE 12
Semantics of MPEG_scene_interactive.trigger.primitive properties

| Name | Type | Usage | Default | Description |
|---|---|---|---|---|
| type | enumeration | O | BV_SPHEROID | Describes the type of |
| | | | | primitive used to activate |
| | | | | the proximity trigger. The |
| | | | | available options are: |
| | | | | BV_CUBOID = 0, |
| | | | | BV_PLANE_REGION = 1, |
| | | | | BV_CYLINDER_ |
| | | | | REGION = 2, |
| | | | | BV_CAPSULE_REGION = |
| | | | | 3, |
| | | | | BV_SPHEROID = 4 |
| | | | | The default is |
| | | | | BV SPHEROID. |
| boundary | number | O | 0.0 | Defines the region of |
| | | | | intersection within the |
| | | | | primitive. if zero, then all |
| | | | | area of the primitive |
| | | | | activates the trigger. |
| | | | | Otherwise, the region of |
| | | | | intersection decreases |
| | | | | following the normal |
| | | | | direction of all sides of the |
| | | | | primitive from its centroid. |
| | | | | For the capsule primitive, it |
| | | | | should be applied over the |
| | | | | radius, top, and base |
| | | | | attributes. |
| transformation | array | O | [1.0, 0.0, 0.0, 0.0, | Floating-point 4 × 4 matrix |
| Matrix | | | 0.0, 1.0, 0.0, 0.0, | that defines the initial |
| | | | 0.0, 0.0, 1.0, 0.0, | orientation, translation, and |
| | | | 0.0, 0.0, 0.0, 1.0] | scale of a primitive. |
| | | | | Formatted in column-major |
| | | | | order. The primitive follows |
| | | | | x+ for width, y+ for height, |
| | | | | z+ for length. The matrix |
| | | | | transformation allows to |
| | | | | transform any primitive |
| | | | | after initialization. |

TABLE 13
Semantical Description of Each Primitive Region

| Name | Type | Usage | Default | Description |
|---|---|---|---|---|
| if (type == | | | | |
| BV_CUBOID) { | | | | |
| width | number | M | | Width of the box. |
| height | number | M | | Height of the box. |
| length | number | M | | Length of the box. |
| centroid | VEC3 | M | | Centroid 3D |
| | | | | coordinate (x, y, z) of |
| | | | | the cube. |
| } | | | | |
| if (type == | | | | |
| BV_PLANE_ | | | | |
| REGION) { | | | | |
| width | number | M | | Width of the plane. |
| height | number | M | | Height of the plane. |
| centroid | VEC2 | M | | Centroid 2D |
| | | | | coordinate (x, y) or |
| | | | | (x, z) or (y, z) of the |
| | | | | plane. |
| } | | | | |
| if (type == BV_ | | | | |
| CYLINDER_ | | | | |
| REGION) { | | | | |
| radius | number | M | | Radius of the |
| | | | | cylinder. |
| length | number | M | | Length of the |
| | | | | cylinder. |
| centroid | VEC3 | M | | Centroid 3D |
| | | | | coordinate (x, y, z) of |
| | | | | the cylinder |
| } | | | | |
| if (type == | | | | |
| BV_CAPSULE_ | | | | |
| REGION) { | | | | |
| radius | number | M | | Radius of the |
| | | | | capsule. |
| baseCentroid | VEC3 | M | | Centroid 3D |
| | | | | coordinate (x, y, z) of |
| | | | | the base semi-sphere |
| | | | | of the capsule. |
| topCentroid | VEC3 | M | | Centroid 3D |
| | | | | coordinate (x, y, z) of |
| | | | | the top semi-sphere |
| | | | | of the capsule. |
| } | | | | |
| if (type == | | | | |
| BV_SPHEROID) | | | | |
| { | | | | |
| radius | number | M | | Radius of the sphere. |
| centroid | VEC3 | M | | Centre 3D coordinate |
| | | | | (x, y, z) of the sphere. |
| } | | | | |

The name of the sematic of action, the type, the usage, the default, and the description according to an example embodiment are provided in Table 14 below.

TABLE 14
Sematic of Action

| Name | Type | Usage | Default | Description |
|---|---|---|---|---|
| type | enumeration | M | | An element that defines the type of |
| | | | | the action. |
| delay | number | O | 0.0 | Duration of delay in second before |
| | | | | executing the action. |
| if (type== | | | | |
| ACTION_ | | | | |
| ACTIVATE){ | | | | |
| activationStatus | enumeration | M | | ENABLED = 0: the node is |
| | | | | processed by the application |
| | | | | DISABLED = 1: the node is |
| | | | | skipped by the application. |
| nodes | array | M | | Indices of the nodes in the nodes |
| | | | | array to set the activation status. |
| } | | | | |
| if (type== | | | | |
| ACTION_ | | | | |
| TRANSFORM){ | | | | |
| transform | | M | | A 4 × 4 transformation matrix to |
| | | | | apply to the nodes. |
| nodes | array | M | | Indices of the nodes in the nodes |
| | | | | array to be transformed. |
| } | | | | |
| if (type == | | | | |
| ACTION_ | | | | |
| BLOCK){ | | | | |
| nodes | array | M | | Indices of the nodes in the nodes |
| | | | | array to lock their related |
| | | | | transforms. |
| } | | | | |
| if (type == | | | | |
| ACTION_ | | | | |
| ANIMATION){ | | | | |
| animation | number | M | | Index of the animation in the |
| | | | | animations array to be considered. |
| animationControl | enumeration | M | | One element of that defines the |
| | | | | control of the animation. |
| } | | | | |
| if (type == | | | | |
| ACTION_ | | | | |
| MEDIA){ | | | | |
| media | number | M | | Index of the media in the |
| | | | | MPEG_media array to be |
| | | | | considered. |
| mediaControl | enumeration | M | | One element of that defines the |
| | | | | control of the media. |
| } | | | | |
| if (type == | | | | |
| ACTION_ | | | | |
| MANIPULATE){ | | | | |
| manipulate | enumeration | M | | One element of that defines the |
| ActionType | | | | action manipulate type. |
| axis | array | O | Up | (x, y, z) coordinates of the axis used |
| | | | | for rotation and sliding. These |
| | | | | coordinates are relative to the local |
| | | | | space created by the user input |
| | | | | described in the |
| | | | | userInputDescription. For example |
| | | | | a “/user/hand/left/pose” user input |
| | | | | trigger creates a local space |
| | | | | attached to the user left hand. |
| userInput | string | M | | Describe the user input related to |
| Description | | | | the manipulation action. The format |
| | | | | follows the OpenXR input path |
| | | | | description as defined in [OpenXR] |
| | | | | section 6. An example is: |
| | | | | “/user/hand/left/aim/pose”. |
| nodes | array | M | | Indices of the nodes in the nodes |
| | | | | array to be manipulated. |
| } | | | | |
| if (type == | | | | |
| ACTION_SET_ | | | | |
| MATERIAL){ | | | | |
| material | number | M | | Index of the material in the |
| | | | | materials array to apply to the set of |
| | | | | nodes. |
| nodes | array | M | | Indices of the nodes in the nodes |
| | | | | array to set their material. |
| } | | | | |
| if (type == | | | | |
| ACTION_ | | | | |
| HAPTIC){ | | | | |
| hapticAction | array(Haptic | M | | List of haptic action nodes as |
| Nodes | ActionNode) | | | defined in Table 43. |
| } | | | | |
| if (type == | | | | |
| ACTION_SET_ | | | | |
| AVATAR) { | | | | |
| avatarAction | string | M | | The avatarAction is a URN that |
| | | | | uniquely identifies the avatar |
| | | | | action. |
| | | | | For the MPEG reference Avatar, a |
| | | | | set of avatar actions and their |
| | | | | respective URNs is defined in Table |
| | | | | H.4.3.2 of Annex H. |
| | | | | For example, the URN |
| | | | | “urn:mpeg:sd:2023:avatar:actionslist/ |
| | | | | speech” referenced in Table |
| | | | | H.4.3.2 of Annex H sets the |
| | | | | optional attributes “microphone” |
| | | | | and “media”. Considering only the |
| | | | | boolean attribute “microphone”, the |
| | | | | nodes in the node array will |
| | | | | activate/deactivate their |
| | | | | “microphone” ability accordingly |
| | | | | when this action is launched. |
| nodes | array | M | | Indices of the nodes in the nodes |
| | | | | array to launch their avatar actions. |

The description of the types of actions of an example embodiment are provided in Table 15 below.

TABLE 15
Type of Action

| Action type | Description |
|---|---|
| ACTION_ACTIVATE = 0 | Set activation status of a node |
| ACTION_TRANSFORM | Set transform to a node |
| ACTION_BLOCK | Block the transform of a node |
| ACTION_ANIMATION | Select and control an animation |
| ACTION_MEDIA | Select and control a media |
| ACTION_MANIPULATE | Select a manipulate action |
| ACTION_SET_MATERIAL | Set new material to nodes |
| ACTION_HAPTIC | Get haptic feedbacks on a set of nodes |
| ACTION_SET_AVATAR | Get avatar related actions |

The description of the types of amination control of an example embodiment are provided in Table 16 below.

TABLE 16
Control of Animation

| Animation Control | Description |
|---|---|
| ANIMATION_PLAY = 0 | Play the animation from time 0 or from |
| | any other time provided by a control. |
| ANIMATION_PAUSE | Pause the animation |
| ANIMATION_RESUME | Resume the animation from the last |
| | pause position. |
| ANIMATION_STOP | Stop the animation |

The description of the types of media control of an example embodiment are provided in Table 17 below.

TABLE 17
Control of Media

| Media Control | Description |
|---|---|
| MEDIA_PLAY = 0 | Play the media from time 0 or from any |
| | other time provided by a control. |
| MEDIA_PAUSE | Pause the media |
| MEDIA_RESUME | Resume the media from the last pause |
| | position. |
| MEDIA_STOP | Stop the media |

The action manipulate type and related description according to example embodiments are provided in Table 18.

TABLE 18
Action Manipulate Type

| Action Manipulate Type | Description |
|---|---|
| ACTION_MANIPULATE_ | The nodes follow the user pointing |
| FREE = 0 | device and its rotation. |
| ACTION_MANIPULATE_ | The nodes move linearly along the |
| SLIDE | provided axis by following the user |
| | pointing device. |
| ACTION_MANIPULATE_ | The nodes translate by following the user |
| TRANSLATE | pointing device. |
| ACTION_MANIPULATE_ | The nodes rotate around the provided |
| ROTATE | axis by following the user pointing |
| | device. |
| ACTION_MANIPULATE_ | Performs a central scaling of the nodes by |
| SCALE | following the user pointing device. |

The name, type, usage, default, and description of behaviors according to example embodiments are provided in Table 19.

TABLE 19
Semantic of Behavior

| Name | Type | Usage | Default | Description |
|---|---|---|---|---|
| triggers | array | M | | Indices of the triggers in the |
| | | | | triggers array considered for this |
| | | | | behavior |
| actions | array | M | | Indices of the actions in the |
| | | | | actions array considered for this |
| | | | | behavior. |
| triggers | string | M | | Set of logical operations to apply |
| Combination | | | | to the triggers |
| Control | | | | A ‘#’ indicates the trigger index, |
| | | | | ‘&’ indicates a logical AND |
| | | | | operation, ‘\|’ a logical OR |
| | | | | operation and ‘~’ a NOT |
| | | | | operation. Parenthesis are used to |
| | | | | group some operations. Such a |
| | | | | syntax may give the following |
| | | | | string: “#1&~#2\|(#3&#4)”. |
| | | | | An empty string is understood as |
| | | | | a logical OR between all the |
| | | | | triggers. |
| | | | | A regex expression (https://json- |
| | | | | schema.org/understanding-json- |
| | | | | schema/reference/regular_express |
| | | | | ions.html) is specified in the |
| | | | | JSON schema to validate this |
| | | | | string. |
| triggers | enu- | M | | Indicates when the combination |
| Activation | meration | | | of the triggers is activated for |
| Control | | | | launching the actions. One |
| | | | | element of that defines when the |
| | | | | combination of the triggers is |
| | | | | activated for launching the |
| | | | | actions. |
| actions | enu- | M | | Defines the way to execute the |
| Control | meration | | | defined actions. |
| | | | | SEQUENTIAL = 0: each defined |
| | | | | action is executed sequentially in |
| | | | | the order of the actions array. |
| | | | | PARALLEL = 1: the defined |
| | | | | actions are executed concurrently. |
| interrupt | number | O | N/A | Index of the action in the actions |
| Action | | | | array to be executed if the |
| | | | | behavior is still on-going and is |
| | | | | no more defined in a newly |
| | | | | received scene update. |
| priority | number | O | 0 | Integer value defining the aptics |
| | | | | associated to the behavior When |
| | | | | several behaviors are in |
| | | | | concurrence to affect the same |
| | | | | node(s) at the same time, the |
| | | | | behavior having the highest |
| | | | | priority value is processed. The |
| | | | | lower priority behavior(s) is not |
| | | | | processed. In the case of |
| | | | | behaviors having the same |
| | | | | priority, the application should |
| | | | | apply its own criteria. |

The trigger activation control and related description for an example embodiment are provided in Table 20 below.

TABLE 20
Trigger Activation Control

| Trigger Activation Control | Description |
|---|---|
| TRIGGER_ACTIVATE_ | Activated when the conditions are first |
| FIRST_ENTER = 0 | met |
| TRIGGER_ACTIVATE_ | Activated each time the conditions are |
| EACH_ENTER | first met |
| TRIGGER_ACTIVATE_ | Activated as long as the conditions are |
| ON | met |
| TRIGGER_ACTIVATE_ | Activated when the conditions are first |
| FIRST_EXIT | no longer met |
| TRIGGER_ACTIVATE_ | Activated each time the conditions are no |
| EACH_EXIT | longer met |
| TRIGGER_ACTIVATE_ | Activated as long as the conditions are |
| OFF | not met |

The property, type, required, default, and description of the HapticActionNode object is provided in Table 21 below.

TABLE 21
Semantic of HapticActionNode object

| Property | Type | Required | Default | Description |
|---|---|---|---|---|
| node | integer | M | | Identifier of the node in the |
| | | | | glTF nodes array. |
| hapticObject | integer | O | N/A | Index to a haptic object in the |
| | | | | hapticObjects array of the |
| | | | | MPEG haptic extension. |
| actionLocation | integer | O | 0xFFFFF | Body part mask specifying |
| | | | FFF | where on the body the signal |
| | | | | can be rendered. |
| | | | | Possible values are detailed |
| | | | | in. |
| washout | boolean | O | False | Specifies whether the action |
| | | | | should trigger a washout |
| | | | | (reset to the origin) of the |
| | | | | associated devices. |
| useCollider | boolean | O | False | Used with a Collision trigger. |
| | | | | If True, the rendering engine |
| | | | | uses collision information to |
| | | | | estimate the desired location |
| | | | | of the haptic feedback on the |
| | | | | body. For haptic materials, |
| | | | | the presentation engine |
| | | | | retrieves the associated haptic |
| | | | | texture media and generates |
| | | | | haptic feedback based on |
| | | | | texture information and |
| | | | | collision position. If false, the |
| | | | | signal is rendered based on |
| | | | | the information specified in |
| | | | | the Haptic file. |
| materialHapticModality | array(enu- | O | N/A | List of haptic material |
| | meration) | | | modalities that is rendered. |
| | | | | Possible values are detailed |
| | | | | in. |
| hapticActionMedias | array(Haptic | M | | List of Haptic Action Media. |
| | ActionMedia) | | | |

The semantics of the HapticActionMedia object according to an example embodiment are provided in Table 22.

TABLE 22
Semantic of the HapticActionMedia object

| Property | Type | Required | Default | Description |
|---|---|---|---|---|
| mediaIndex | integer | M | | Index in the accessors |
| | | | | array of the associated |
| | | | | haptic data. |
| perceptionIndices | array(integer) | M | | Indices of the |
| | | | | perceptions of the |
| | | | | media that is rendered. |
| | | | | If the list is empty |
| | | | | all perceptions are |
| | | | | rendered |
| hapticModality | array(enumeration) | O | N/A | List of haptic |
| | | | | modalities that can |
| | | | | be rendered. |
| | | | | Possible values are |
| | | | | described in. |
| hapticControl | enumeration | O | HAPTIC_ | One element of that |
| | | | PLAY | defines the control of |
| | | | | the haptic rendering. |
| loop | boolean | O | False | Specifies if the haptic |
| | | | | rendering of the data |
| | | | | should be |
| | | | | continuously looping. |

The types of haptic modalities according to example embodiments are provided in Table 23 below.

TABLE 23
List of haptic modalities

Pressure = 0
Acceleration
Velocity
Position
Temperature
Vibrotactile
Water
Wind
Force
Electrotactile
Vibrotactile Texture
Stiffness
Friction
Other

The haptic material modalities according to example embodiments are provided in Table 24 below.

TABLE 24
List of haptic Material Modalities

Stiffness = 0
Friction
Vibrotactile Texture
Temperature
Vibration
Custom

Body part masks according to example embodiments are provided in Table 2 below.

TABLE 25
Body part masks

| | Name | Body_part_mask (binary) | Hexadecimal | Decimal |
|---|---|---|---|---|
| 0 | Unspecified | 000000000000000000000000 | 0x00000000 | 0 |
| | | 00000000 | | |
| 1 | Head Face | 000000000000000000000000 | 0x00000001 | 1 |
| | | 00000001 | | |
| 2 | Head | 000000000000000000000000 | 0x00000002 | 2 |
| | Back/Neck/ | 00000010 | | |
| | Ears | | | |
| 3 | Mouth Bag | 000000000000000000000000 | 0x00000004 | 4 |
| | | 00000100 | | |
| 4 | Lower Jaw | 000000000000000000000000 | 0x00000008 | 8 |
| | | 00001000 | | |
| 5 | Upper Jaw | 000000000000000000000000 | 0x00000010 | 16 |
| | | 00010000 | | |
| 6 | Eye Left | 000000000000000000000000 | 0x00000020 | 32 |
| | | 00100000 | | |
| 7 | Eye Right | 000000000000000000000000 | 0x00000040 | 64 |
| | | 01000000 | | |
| 8 | Chest Front | 000000000000000000000000 | 0x00000080 | 128 |
| | | 10000000 | | |
| 9 | Chest Back | 000000000000000000000001 | 0x00000100 | 256 |
| | | 00000000 | | |
| 10 | Upper Arm | 000000000000000000000010 | 0x00000200 | 512 |
| | Left | 00000000 | | |
| 11 | Lower Arm | 000000000000000000000100 | 0x00000400 | 1 024 |
| | Left | 00000000 | | |
| 12 | Hand Left | 000000000000000000001000 | 0x00000800 | 2 048 |
| | | 00000000 | | |
| 13 | Upper Arm | 000000000000000000010000 | 0x00001000 | 4 096 |
| | Right | 00000000 | | |
| 14 | Lower Arm | 000000000000000000100000 | 0x00002000 | 8 192 |
| | Right | 00000000 | | |
| 15 | Hand Right | 000000000000000001000000 | 0x00004000 | 16 384 |
| | | 00000000 | | |
| 16 | Abdomen | 000000000000000010000000 | 0x00008000 | 32 768 |
| | Front | 00000000 | | |
| 17 | Abdomen | 000000000000000100000000 | 0x00010000 | 65 536 |
| | Back | 00000000 | | |
| 18 | Upper Leg | 000000000000001000000000 | 0x00020000 | 131 072 |
| | Left | 00000000 | | |
| 19 | Lower Leg | 000000000000010000000000 | 0x00040000 | 262 144 |
| | Left | 00000000 | | |
| 20 | Foot Left | 000000000000100000000000 | 0x00080000 | 524 288 |
| | | 00000000 | | |
| 21 | Upper Leg | 000000000001000000000000 | 0x00100000 | 1 048 576 |
| | Right | 00000000 | | |
| 22 | Lower Leg | 000000000010000000000000 | 0x00200000 | 2 097 152 |
| | Right | 00000000 | | |
| 23 | Foot Right | 000000000100000000000000 | 0x00400000 | 4 194 304 |
| | | 00000000 | | |
| 24 | Reserved | 000000000100000000000000 | 0x00800000- | 8 388 608- |
| | | 00000000- | 0x80000000 | 2 147 483 6 |
| | | 100000000000000000000000 | | 48 |
| | | 00000000 | | |

Examples of body part combinations according to example embodiments are provided in Table 26 below.

TABLE 26
Examples of body part combinations

| Name | Body_part_mask (binary) | Hexadecimal | Decimal |
|---|---|---|---|
| Right arm | 00000000000000000111000000000000 | 0x00007000 | 28 672 |
| Left arm | 00000000000000000000111000000000 | 0x00000E00 | 3 584 |
| Right leg | 00000000011100000000000000000000 | 0x00700000 | 7 340 032 |
| Left leg | 00000000000011100000000000000000 | 0x000E0000 | 917 504 |
| Upper body | 00000000000000011111111111111111 | 0x0001FFFF | 131 071 |
| Lower body | 00000000011111100000000000000000 | 0x007E0000 | 8 257 536 |
| Full body | 11111111111111111111111111111111 | 0xFFFFFFFF | 4 294 967 295 |

TABLE 27
List of Haptic controls

| Haptic Control | Description |
|---|---|
| HAPTIC_PLAY = 0 | Start the rendering of the haptic data from time |
| | 0 or from any other time provided by a control |
| HAPTIC_PAUSE | Pause the rendering of the haptic data |
| HAPTIC_RESUME | Resume the rendering of the haptic data from |
| | the last pause position. |
| HAPTIC_STOP | Stop the rendering of the haptic data |

In complement to the interactivity objects defined in the glTF scene-level extension, some additional data could be provided at the level of the affected glTF nodes to specialize the trigger activation. The semantic of the MPEG_node_interactivity extension is shown in Table 28.

TABLE 28
Semantic of the MPEG_node_interactivity extension

| Name | Type | Usage | Default | Description |
|---|---|---|---|---|
| triggers | array | M | | Array of node triggers. Only distinct |
| | | | | types are allowed. The minimum |
| | | | | size of this array is 1, and the |
| | | | | maximum size is size of trigger |
| | | | | types as defined in this specification. |

The semantic of the MPEG_node_interactivity.trigger extension is shown in Table 29.

TABLE 29
Semantic of the MPEG_node_interactivity.trigger extension

| Name | Type | Usage | Default | Description |
|---|---|---|---|---|
| type | enu- | M | | An element that defines |
| | meration | | | the type of the trigger. |
| if (type == | | | | |
| TRIGGER_ | | | | |
| COLLISION){ | | | | |
| collider | integer | M | | the index of the mesh |
| | | | | element that provides the |
| | | | | collider geometry for the |
| | | | | current node. |
| | | | | The collider mesh may |
| | | | | reference a material. |
| isStatic | boolean | M | | If True, the collider is |
| | | | | defined as a static collider. |
| usePhysics | boolean | M | | Indicates if the object are |
| | | | | considered by the physics |
| | | | | simulation. |
| if (usePhysics) { | | | | |
| needPrecise | Boolean | O | false | If true, the physics engine |
| Collision | | | | should handle the collision |
| Detection | | | | detection more accurately |
| | | | | by increasing the detection |
| | | | | rate for this node. |
| linearDamping | Number | O | 0 | A non-negative value, in |
| | | | | second⁻¹ (s⁻¹), as defined |
| | | | | in the international unit |
| | | | | system. It defines the |
| | | | | linear drag coefficient |
| | | | | which corresponds to the |
| | | | | rate of decrease of the |
| | | | | linear velocity over time. |
| | | | | It is used to compute a |
| | | | | new velocity value V(t) at |
| | | | | each simulation step (dt): |
| | | | | V(t + dt) = V(t)*(1 − |
| | | | | linearDamping*dt), the |
| | | | | velocity being clamped to |
| | | | | 0. |
| angularDamping | number | O | 0 | A non-negative value, in |
| | | | | second⁻¹ (s⁻¹), as defined |
| | | | | in the international unit |
| | | | | system. It defines the |
| | | | | angular drag coefficient |
| | | | | which corresponds to the |
| | | | | rate of decrease of the |
| | | | | angular velocity over time. |
| | | | | It is used to compute a |
| | | | | new velocity value V(t) at |
| | | | | each simulation step (dt): |
| | | | | V(t + dt) = V(t)*(1 − |
| | | | | angularDamping*dt), the |
| | | | | velocity being clamped to |
| | | | | 0. |
| useGravity | boolean | M | | Indicates if the gravity |
| | | | | affects the object |
| mass | number | M | | Mass of the object in |
| | | | | kilogram as defined in the |
| | | | | international unit system.. |
| restitution | number | M | | Provides the ratio of the |
| | | | | final to initial relative |
| | | | | velocity between two |
| | | | | objects after they collide. |
| staticFriction | number | M | | Unitless friction |
| | | | | coefficient as defined in |
| | | | | the Coulomb friction |
| | | | | model. Friction is the |
| | | | | quantity which prevents |
| | | | | surfaces from sliding off |
| | | | | each other. StaticFriction |
| | | | | is used when the object is |
| | | | | lying still. It will prevent |
| | | | | the object from starting to |
| | | | | move. |
| dynamicFriction | number | M | | Unitless friction |
| | | | | coefficient as defined in |
| | | | | the Coulomb friction |
| | | | | model. When a large |
| | | | | enough force is applied to |
| | | | | the object, the |
| | | | | dynamicFriction is used, |
| | | | | and will attempt to slow |
| | | | | down the object while in |
| | | | | contact with another. |
| } | | | | |
| primitives | array | O | N/A | List of primitives used to |
| | (Primitive) | | | activate the proximity or |
| | | | | collision trigger. |
| } | | | | |
| if (type == | | | | |
| TRIGGER_ | | | | |
| PROXIMITY){ | | | | |
| allowOcclusion | boolean | M | | Indicates if occlusion by |
| | | | | other nodes should be |
| | | | | considered |
| upperDistance | number | O | 1 | The weight applied |
| Weight | | | | to the distanceUpperLimit |
| | | | | parameter defined at scene |
| | | | | level |
| lowerDistance | number | O | 1 | The weight applied |
| Weight | | | | to the distanceLowerLimit |
| | | | | parameter defined at scene |
| | | | | level |
| primitives | array | O | N/A | List of primitives used to |
| | (Primitive) | | | activate the proximity or |
| | | | | collision trigger. |
| } | | | | |
| if (type == | | | | |
| TRIGGER_ | | | | |
| USER_INPUT){ | | | | |
| userInput | array | M | | Provides additional |
| Parameters | | | | information related to the |
| | | | | user inputs (eg “max |
| | | | | speed = 0.5”) |
| } | | | | |
| if (type == | | | | |
| TRIGGER_ | | | | |
| VISIBILITY){ | | | | |
| allowsPartial | boolean | M | | The visibility computation |
| Occlusion | | | | takes into account both |
| | | | | the occultation by other |
| | | | | node(s) and the camera |
| | | | | frustrum. If the |
| | | | | allowsPartialOcclusion |
| | | | | Boolean is TRUE, then a |
| | | | | partial visibility of this |
| | | | | node activates the trigger. |
| | | | | If the |
| | | | | allowsPartialOcclusion |
| | | | | Boolean is FALSE, then |
| | | | | this node may be fully in |
| | | | | the camera frustrum and |
| | | | | not be occluded by any |
| | | | | other node(s) except the |
| | | | | nodes listed in the nodes |
| | | | | array to activate the |
| | | | | trigger. |
| nodes | array | 0 | N/A | Set of nodes that is not |
| | | | | considered for the |
| | | | | visibility computation, |
| | | | | when the |
| | | | | allowsPartialOcclusion is |
| | | | | FALSE. |
| mesh | number | 0 | N/A | Index of the mesh in the |
| | | | | scene meshes array that |
| | | | | will be used to compute |
| | | | | visibility. |
| } | | | | |

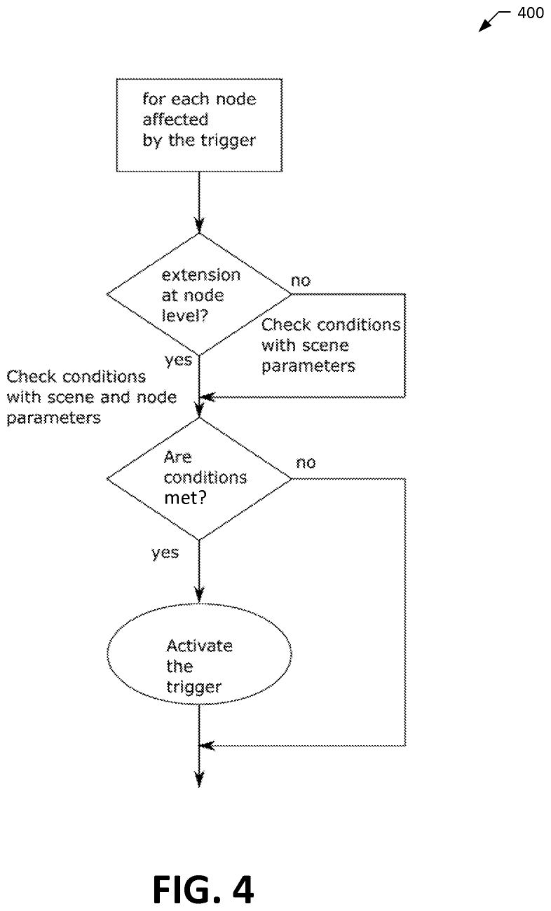

FIG. 4 depicts a processing model 400 for the activation of a single trigger in accordance with one or more embodiments of the present disclosure. When a scene description file becomes available, the Presentation Engine parses the related glTF file. In various embodiments, the Presentation Engine creates each behavior composed of triggers and actions described at the interactivity scene level extension. The Presentation Engine specializes the trigger for each affected node with the additional data provided at the interactivity node level extension if present. At runtime, the presentation Engine iterates on each behavior and performs the following tasks including but not limited to, checking the activation status of each trigger of this behavior by following the procedure detailed in FIG. 4, and checking the logical combination of these trigger status. In an instance that this status satisfies the triggersActivationControl value, the Presentation Engine launches the corresponding actions.

When several behaviors are in concurrence to affect the same node(s) at the same time, the behavior having the highest priority value will be processed. The lower priority behavior(s) will not be processed. In the case of behaviors having the same priority, the application should apply its own criteria.

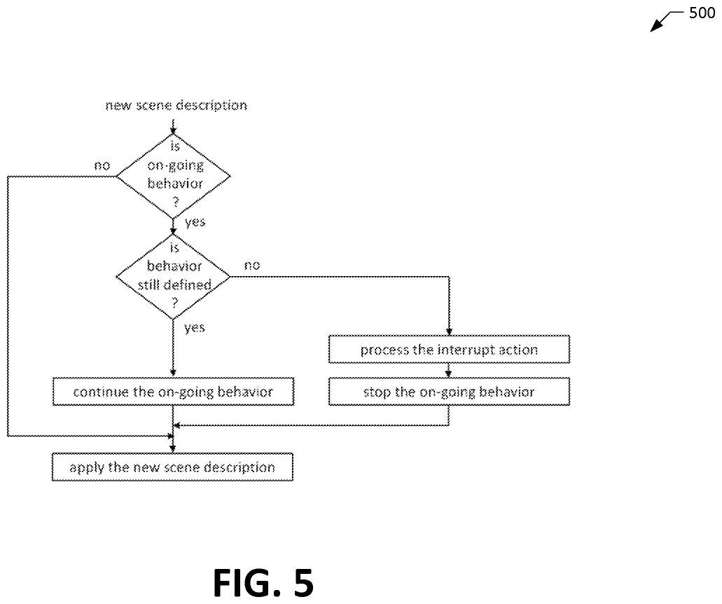

FIG. 5 depicts a processing model 500 when a new scene description update is received in accordance with one or more embodiments of the present disclosure. When a new scene description update is received, the application follows the procedure detailed in FIG. 5. An on-going behavior corresponds to a behavior including but not limited to, having its triggers status verifying the triggersActivationControl value for that frame, having previously launched a play action related to a media/animation, and having previously launched an action with a delay not yet expired. To check if the behavior is still defined, the application should check if the scene description update leads to at least one of a removal of this behavior in the behaviors array, modification of any parameter of this behavior (e.g. by adding a new trigger, by changing the trigger activation control, . . . ), and removal of any of the referenced nodes by the action. The application processes the interrupt action only if the timing requirement of the scene description update is met.

If the scene description document contains a description of physics properties based on another physics model, then that physics model takes precedence in the processing of the scene. Otherwise, the application handles a physics simulation if the use Physics Boolean is TRUE on any of the collision trigger extensions defined at the node level. When a collision occurs between two nodes, the application should calculate the combination of the restitution, static friction and dynamic friction values based on the values provided by the collision trigger extension of the two nodes.

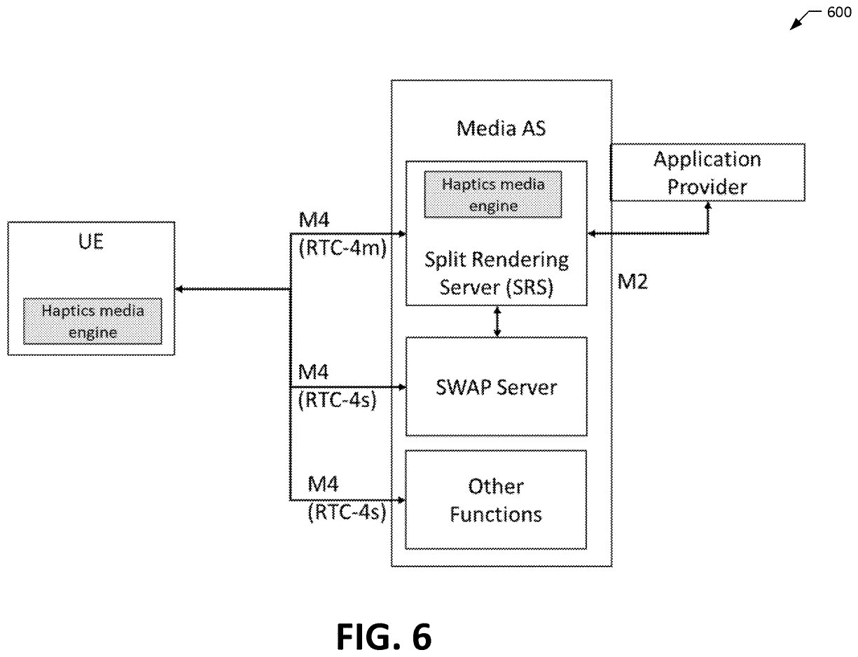

FIG. 6 depicts haptic media functions in the user plane architecture 600 for split management architecture in accordance with one or more embodiments of the present disclosure. A 3GPP UE may use split rendering for media as defined in TS 26.565 or as defined in TS 26.567 (with IMS support). Typical use cases for split rendering of haptic media include immersive gaming and immersive communication. Basic split rendering support for haptics is defined in TR 26.854.

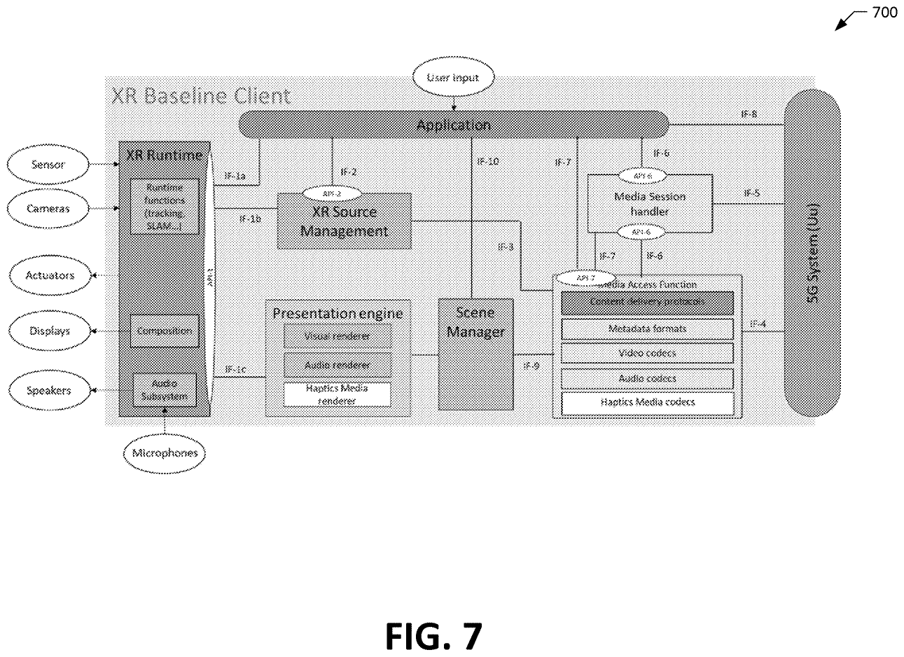

FIG. 7 depicts haptic media entities in the XR baseline client architecture 700 in accordance with one or more embodiments of the present disclosure. The haptics media engines in the Media Application Server (AS) and in the UE need to make sure that the format of the haptics media sent by the Media AS is understandable to the UE. The haptics media entities on the XR baseline Client consist of the haptic media codec and the haptic renderer. The haptic media codec handles and decompresses a compressed haptics media bitstream as illustrated in the Media Access Function (MAF) function of the Split Rendering Client (SRC) along with Audio and Video codecs. The haptic renderer handles the rendering of haptics effects using the targeted actuators as illustrated in the presentation engine function of the SRC.

When a UE intends to offload part of its haptics media processing to the SRS, the SRC and the SRS negotiate the desired haptics media capabilities (or profile) on the M4 interface using a SWAP (Simple WebRTC Application Protocol) message or a data channel message, the SRS processes and renders the haptics media content and may use pose or interaction information to spatialized the rendered haptics media content in correlation with other rendered media stream (scene, video, objects, audio), and the SRS transmits to the UE the resulting haptics media streams. The UE decodes and renders the haptics media stream.

A split rendering session is configured using a configuration message. Table 30 below shows the configuration format defined in TS 26.565.

TABLE 30
Split Rendering Configuration Format

| | | Cardi- | |
|---|---|---|---|
| Name | Type | nality | Description |
| rendering | Array | 0 . . . 1 | Provides a set of flags to |
| Flags | (SR_ | | activate/deactivate selected rendering |
| | CONFIG_ | | functions. The defined |
| | FLAGS) | | SR_CONFIG_FLAGS are: |
| | | | FLAG_ALPHA_BLENDING |
| | | | FLAG_DEPTH_COMPOSITION |
| | | | FLAG_EYE_GAZE_TRACKING |
| split | array | 0 . . . 1 | A list of supported split-rendering |
| Rendering | (URI) | | profile identifiers on the UE. The |
| Profile | | | profile identifiers are listed in Annex |
| | | | C for each profile. |
| device | Object | 0 . . . 1 | Device capabilities as defined in TS |
| Capabilities | | | 26.119 [4], clause 6.1. |
| space | Object | 0 . . . 1 | The space configuration is typically |
| Config- | | | sent by the split rendering server to |
| uration | | | the split rendering client. Upon |
| | | | reception of this information, the |
| | | | SR client uses this information to |
| | | | create the reference and action |
| | | | spaces as well as to agree on |
| | | | common identifiers for the XR |
| | | | spaces. |
| reference | Array | 0 . . . 1 | An array of reference spaces and their |
| Spaces | | | identifiers. |
| id | number | 1 . . . 1 | A unique identifier of the XR space in |
| | | | the context of the split rendering |
| | | | session. |
| refSpace | enum | 1 . . . 1 | One of the defined reference spaces in |
| | | | OpenXR. These may be: |
| | | | XR_REFERENCE_SPACE_TYPE_ |
| | | | VIEW, |
| | | | XR_REFERENCE_SPACE_TYPE_ |
| | | | LOCAL, or |
| | | | XR_REFERENCE_SPACE_TYPE_ |
| | | | STAGE. |
| action | Array | 0 . . . 1 | An array of action spaces that need to |
| Spaces | | | be defined by the split rendering client |
| | | | in the XR session. |
| id | number | 1 . . . 1 | A unique identifier of the XR space in |
| | | | the context of the split rendering |
| | | | session. |
| actionId | number | 1 . . . 1 | Provides the unique identifier of the |
| | | | action. |
| subaction | string | 1 . . . 1 | The subaction path identifies the |
| Path | | | action, which can then be mapped by |
| | | | the XR runtime to user input |
| | | | modalities. |
| initialPose | Pose | 0 . . . 1 | Provides the initial pose of the new |
| | | | XR space's origin. |
| view | Object | 0 . . . 1 | Conveys the view configuration that is |
| Config- | | | configured for the XR session. |
| uration | | | |
| type | Enum | 1 . . . 1 | The type indicates the view |
| | | | configuration. Defined values are |
| | | | MONO and STEREO. Other values |
| | | | may be added. |
| width | number | 1 . . . 1 | The recommended width of the |
| | | | swapchain image. |
| height | number | 1 . . . 1 | The recommended height of the |
| | | | swapchain image. |
| composition | string | 1 . . . 1 | An identifier of the selected |
| Layer | | | composition layer. |
| minPose | number | 0 . . . 1 | The minimum time interval between |
| Interval | | | two consecutive pose information |
| | | | instances sent to the network, in |
| | | | milliseconds. |
| fovs | Array | 0 . . . 1 | An array that provides a list of the |
| | | | field of views (FoV) associated with |
| | | | each view. |
| fov | Object | 1 . . . n | Indicates the four sides of the field of |
| | | | view used for the projection of the |
| | | | corresponding XR view. |
| | | | The number of views n is determined |
| | | | by the type enum of the |
| | | | viewConfiguration. Both the |
| | | | viewPoses in the Pose Format and the |
| | | | fovs arrays will be ordered in a |
| | | | consistent way (i.e., a same index can |
| | | | be used to retrieve the view pose and |
| | | | the related FoV information). |
| angleLeft | number | 1 . . . 1 | The angle of the left side of the field |
| | | | of view. For a symmetric field of view |
| | | | this value is negative. |
| angleRight | number | 1 . . . 1 | The angle of the right side of the field |
| | | | of view. |
| angleUp | number | 1 . . . 1 | The angle of the top part of the field |
| | | | of view. |
| angleDown | number | 1 . . . 1 | The angle of the bottom part of the |
| | | | field of view. For a symmetric field of |
| | | | view this value is negative. |
| environment | enum | 1 . . . 1 | The type indicates the environment |
| Blend | | | blend mode configuration. Defined |
| Mode | | | values are OPAQUE, ADDITIVE and |
| | | | ALPHA_BLEND. Other values may |
| | | | be added. |
| action | Array | 0 . . . 1 | This contains a list of the actions that |
| Config- | | | are to be defined by the SR client. |
| uration | | | |
| action | Object | 1 . . . n | A definition of a single action object. |
| id | number | 1 . . . 1 | A unique identifier of the action. |
| actionType | enum | 1 . . . 1 | The type of the action state. This can |
| | | | be a Boolean, float, vector2, pose, |
| | | | vibration output, etc. |
| subaction | string | 1 . . . n | An array of subaction paths associated |
| Paths | | | with this action. The split rendering |
| | | | client will provide the state of all |
| | | | defined sub-action paths. |
| extra | Object | 0 . . . 1 | A placeholder for addition |
| Config- | | | configuration information. |
| urations | | | |

For the carriage of metadata defined in clause, such as pose and action information, the SRS and SRC will use the WebRTC or IMS data channel. The data channel sub-protocol is identified as “3gpp-sr-metadata” in TS 26.565, which will be included in the dcmap attribute of the SDP. The split rendering metadata message format is set to text-based and the messages is UTF-8 encoded JSON messages. A data channel message may carry one or more split rendering messages as defined in accordance with an example embodiment in Table 31.

TABLE 31
Split Rendering Metadata Messages Format

| Name | Type | Cardinality | Description |
|---|---|---|---|
| messages | Array(Message) | 1 . . . n | A list of split rendering |
| | | | metadata messages. Each |
| | | | message is formatted |
| | | | according to the Message data |
| | | | type as defined in Table 8.3.3- |
| | | | 2. |

Each split rendering message of an example embodiment follows the format specified in Table 32.

TABLE 32
Split Rendering Metadata Message Data Type

| Name | Type | Cardinality | Description |
|---|---|---|---|
| id | string | 1 . . . 1 | An unique identifier of the |
| | | | message in the scope of the |
| | | | data channel session. |
| Type | string | 1 . . . 1 | A urn that identifies the |
| | | | message type. |
| Message | object | 1 . . . 1 | The message content |
| | | | depends on the message type. |
| sendingAtTime | number | 0 . . . 1 | The time when the split |
| (ref. T1′) | | | rendering metadata message |
| | | | is transmitted from the split |
| | | | rendering client to the split |
| | | | rendering server. |

A SRS may be implemented in a Media AS, an IMS Media Function or a IMS Application Server, or any network entity as defined by 3GPP.

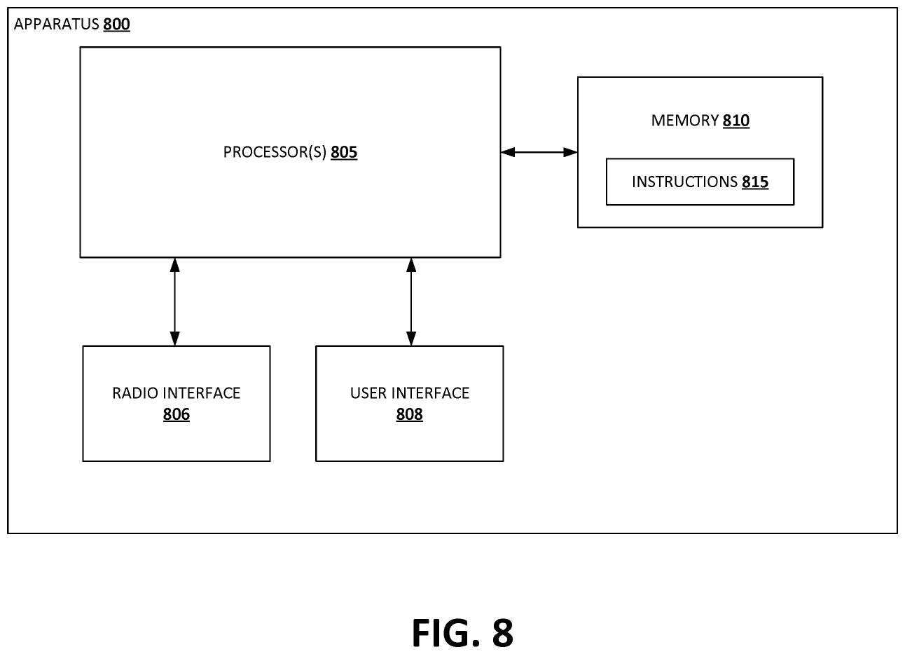

In one or more embodiments, haptic rendering system and method may be enabled by employing an apparatus 800 as depicted in FIG. 8. The apparatus 800 may be embodied by and/or incorporated into an access point (AP) (e.g., the one or more APs), a station (STA) (e.g., the one or more STAs), and/or another device discussed with respect to FIG. 3.

Regardless of the manner in which the apparatus 800 is embodied, the apparatus 800 includes, is associated with, and/or is in communication with: at least one processor 805, at least one memory 810, and a communication interface 815. In one or more embodiments, the apparatus 800 comprises, for example, the at least one processor 805 and the at least one memory 810 storing instructions 815 that, when executed by the at least one processor 805, cause the apparatus 800 at least to perform the method or methods as disclosed herein, and any of the embodiments thereof. In an example, the at least one memory 810 and the instructions 815 (e.g., a computer program code, software), are configured, with the at least one processor 805, to cause the apparatus 800 to perform the method or methods as disclosed herein, and any of the embodiments thereof.

In some embodiments, the processor 805 may be in communication with the memory 810 via a bus for passing information among components of the apparatus 800. The memory 810 may be non-transitory and may include, for example, one or more volatile and/or non-volatile memories. In other words, for example, the memory 810 may be an electronic storage device (e.g., a computer readable storage medium) comprising gates configured to store data (e.g., bits) that may be retrievable by a machine (e.g., a computing device like the processor). The memory 810 may be configured to store information, data, content, applications, instructions, or the like for enabling the apparatus to carry out various functions in accordance with an example embodiment of the present disclosure. For example, the memory 810 could be configured to buffer input data for processing by the processor. Additionally, or alternatively, the memory 810 may be configured to store instructions for execution by the processor 805.

The processor 805 may comprise circuitry, or be constituted as circuitry or circuitries, the circuitry or circuitries being configured to perform phases of methods in accordance with certain example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The memory 810 may be implemented using any suitable data storage technology. The memory may comprise a database for storing data. The memory 810 may be at least in part external to apparatus 800 but accessible to apparatus 800.

The instructions 815 may be comprised in a computer readable medium or a non-transitory computer readable medium. A term non-transitory, as used herein, is a limitation of the medium itself (e.g., tangible, not a signal) as opposed to a limitation on data storage persistency (e.g., random access memory, RAM, vs. read only memory, ROM).

The apparatus 800 comprises a radio interface 806. The radio interface 806 may provide the apparatus 800 with communication capabilities. The radio interface 806 may comprise a receiver configured to receive information in accordance with at least one cellular or non-cellular standard. The radio interface 806 may comprise a transmitter configured to transmit information in accordance with at least one cellular or non-cellular standard. The receiver may comprise more than one receiver. The transmitter may comprise more than one transmitter. The radio interface 806 may comprise a transceiver configured to receive and transmit information in accordance with at least one cellular or non-cellular standard. The transceiver may comprise more than one transceiver.

The apparatus 800 may optionally comprise a user interface 808 comprising, for example, at least one of a keypad, a microphone, a touch display, a display, a speaker, etc. The user interface 808 may be used to control the apparatus by the user. The user interface 808 may be external to the apparatus 800. For example, the apparatus 800 may be connected to another device, such as a computer, either via wireless or wired connection, and the apparatus 800 is controlled by the user via the computer.

Certain embodiments solve the problems of inefficient haptic rendering and lack of dynamic prioritization through a combination of two key, interconnected mechanisms: a priority queue and dynamic, object-specific distance-based culling (sphere of influence). Furthermore, at least some embodiments incorporate velocity-based culling for enhanced efficiency.

Certain embodiments of the present disclosure are directed to creating a foundational framework for efficiently rendering haptic feedback in real-time interactive applications, such as virtual reality (VR) or augmented reality (AR) environments, and games. Haptic rendering, the process of generating tactile sensations for virtual objects, is computationally expensive. Unlike visual rendering, where distant objects can be rendered at low detail or omitted entirely, haptic feedback often needs to be calculated for objects that are potentially interactable, even if they are not currently being touched. This need for haptic feedback to be calculated may be because a user might suddenly interact with an object. Certain embodiments address this challenge by implementing a dynamic prioritization and culling system. The goal is to render only the most relevant haptic effects at any given time, reducing the computational load and improving performance without sacrificing a realistic and responsive haptic experience. This is achieved through the following primary mechanisms.

In various embodiments, a priority queue data structure is employed to manage haptic objects. Each object is assigned a priority score based on several factors. In various embodiments, the priority queue efficiently maintains a sorted list of objects, allowing the system to quickly identify the most important objects to render. In various embodiments, the priority queue uses a heap data structure, which is efficient for inserting, deleting, and retrieving the highest-priority element. In various embodiments, a dynamic priority score is calculated for each haptic object based on the following factors including base priority, proximity factor, and velocity factor. In various embodiments, base Priority is an inherent, object-type-specific value representing the object's importance within the application (e.g., a bullet has a higher base priority than a static wall). In various embodiments, Proximity Factor is a non-linear function of the distance between the user's haptic interaction point (e.g., virtual hand) and the object. This factor uses an inverse-distance or exponential decay, giving significantly higher priority to very close objects. In various embodiments, Velocity Factor considers the object's velocity relative to the user. Velocity Factor prioritizes objects moving towards the user, using the dot product of the object's velocity vector and the vector from the object to the user. Objects moving quickly away from the user receive a lower velocity factor or are culled entirely. In various embodiments, to further reduce the number of objects requiring detailed haptic calculations, a sphere of influence is defined around each haptic object. In various embodiments, if the user's haptic interaction point (e.g., a virtual hand) is outside this sphere, the object is considered too far away to generate a noticeable haptic effect and is temporarily culled from the rendering process. This spatial culling significantly reduces the computational burden.

In various embodiments, Dynamic Haptic Prioritization and Culling Engine (DHPC) utilizes a sphere of influence around each haptic object as a primary culling mechanism. However, this sphere of influence is not static, but is instead: object type dependent, dynamically adjusted, and attenuation based. The sphere's initial radius is based on the object's type and inherent properties, allowing for different influence ranges for different types of haptic events (e.g., a small sphere for a bullet, a larger one for an explosion). In various embodiments, a base radius parameter is used. The radius can change dynamically based on object state. For explosions, the sphere expands over time, simulating a propagating shockwave. For projectiles, the sphere is elongated in the direction of the projectile's velocity, creating a “cone of influence” that anticipates future interactions. The sphere of influence radius is calculated using an attenuation factor based on the physical properties of the medium, object properties, and signal strength.

In various embodiments, in addition to the sphere of influence, DHPC implements velocity-based culling. Objects that are within the sphere of influence but moving rapidly away from the user are culled, further optimizing performance. This uses a dot product calculation and configurable speed and alignment thresholds. This combination of a priority queue and sphere-of-influence culling allows the system to dynamically adapt to changing conditions in the virtual environment and efficiently manage the rendering of haptic effects. The result is a more responsive and performant haptic experience, even in scenes with many potentially interactable objects. Certain embodiments therefore lay the groundwork for more sophisticated haptic rendering techniques by providing a solid foundation for managing haptic object complexity.

In summary, the DHPC provides a robust, efficient, and adaptable foundation for real-time haptic rendering in complex VR/AR environments. The DHPC prioritizes and culls haptic objects dynamically, ensuring that computational resources are focused on the most relevant and perceptible sensations, leading to a more responsive and realistic haptic experience. This project sets the stage for further enhancements, such as multi-level intensity scaling and user focus integration.

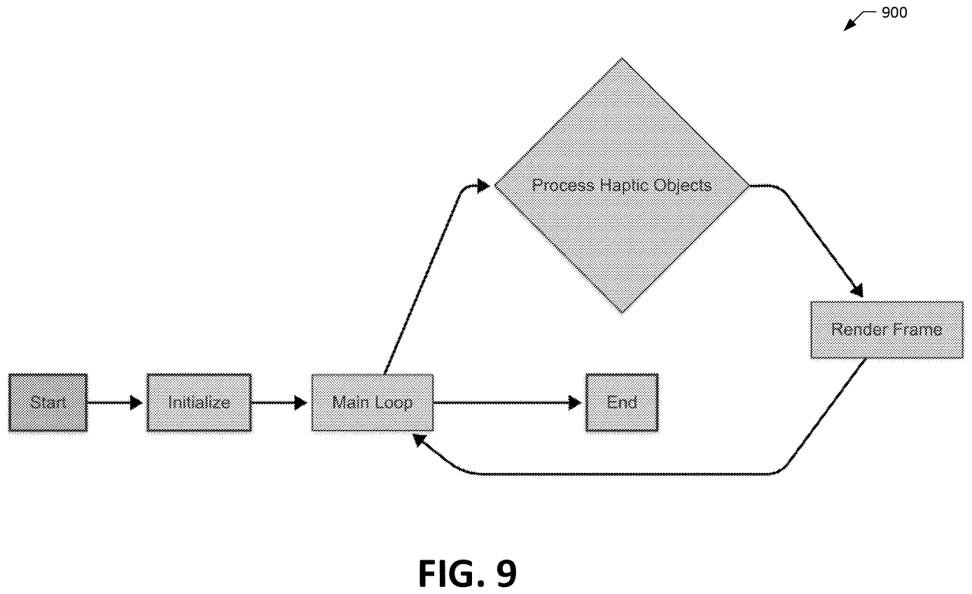

FIG. 9 is a flowchart depicting a method 900 in accordance with one or more example embodiments of the present disclosure. In various embodiments, instead of processing all haptic objects within a fixed radius, a priority queue data structure (implemented as a heap) is used.

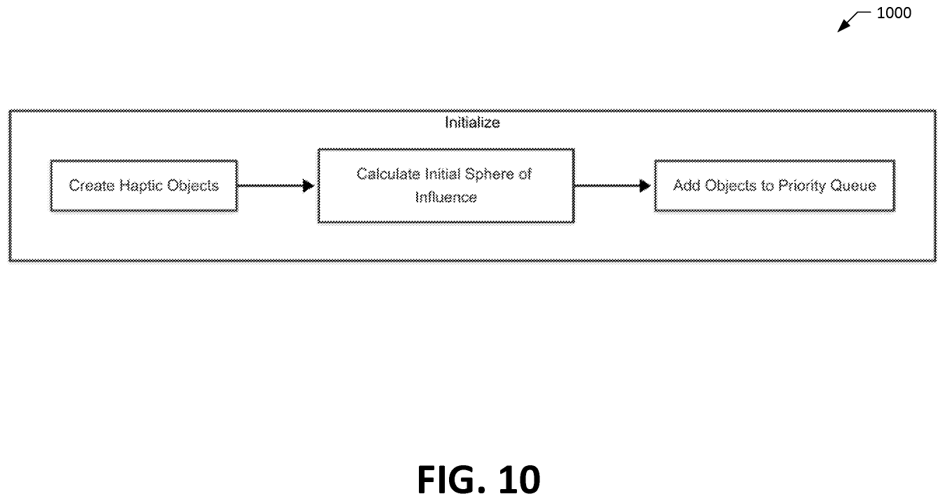

FIG. 10 is a flowchart depicting a method in 1000 accordance with one or more example embodiments of the present disclosure. FIG. 10 depicts the initialization phase of the priority queue. A priority queue data structure is employed to manage haptic objects. Each object is assigned a priority score based on several factors. The priority queue efficiently maintains a sorted list of objects, allowing the system to quickly identify the most important objects to render. The priority queue uses a heap data structure, which is efficient for inserting, deleting, and retrieving the highest-priority element. The priority score is calculated for each haptic object based on the following factors including base priority, proximity factor, and velocity factor. Base Priority is an inherent, object-type-specific value representing the object's importance within the application (e.g., a bullet has a higher base priority than a static wall). Proximity Factor is a non-linear function of the distance between the user's haptic interaction point (e.g., virtual hand) and the object. This factor uses an inverse-distance or exponential decay, giving significantly higher priority to very close objects. Velocity Factor considers the object's velocity relative to the user. Velocity Factor prioritizes objects moving towards the user, using the dot product of the object's velocity vector and the vector from the object to the user. Objects moving quickly away from the user receive a lower velocity factor or are culled entirely (see below). The priority score is calculated using the formula. The proximity factor uses a non-linear function (e.g., inverse-distance, exponential decay function, or sigmoidal function) for a more nuanced response. The velocity factor considers the component of velocity towards the user.

The heap data structure of the priority queue is specifically designed for efficient retrieval of the highest-priority element (O(1) time complexity for retrieval, O(log n) for insertion and deletion). This is a significant improvement over iterating through a simple list.2.

Furthermore, each haptic object is associated with a “sphere of influence”—a radius defining its potential haptic reach. Objects outside this sphere are completely culled from the rendering process. Critically, this sphere of influence is not fixed. Its radius is dynamically calculated based on object type and can be further shaped (e.g., into an ellipsoid for projectiles) based on object velocity. Added as a further optimization, objects within the sphere of influence, but moving rapidly away from the user, are also culled. This uses a dot-product calculation to determine the direction of relative movement.

In various embodiments, the combination of the priority queue, dynamic sphere of influence, velocity-based culling, and refined priority score calculation creates a synergistic effect including Coarse-Grained Filtering (Dynamic Sphere of Influence), directional filtering, and fine-grained prioritization. Coarse-grained filtering by the sphere of influence provides a fast, object-specific filter, eliminating obviously irrelevant objects based on distance and, potentially, object behavior. Directional filtering further refines the set of considered objects by eliminating those moving rapidly away from the user. Fine-grained prioritization demonstrated by the priority queue then takes the remaining objects and orders them based on their calculated priority score, which considers base priority, proximity, and velocity towards the user.

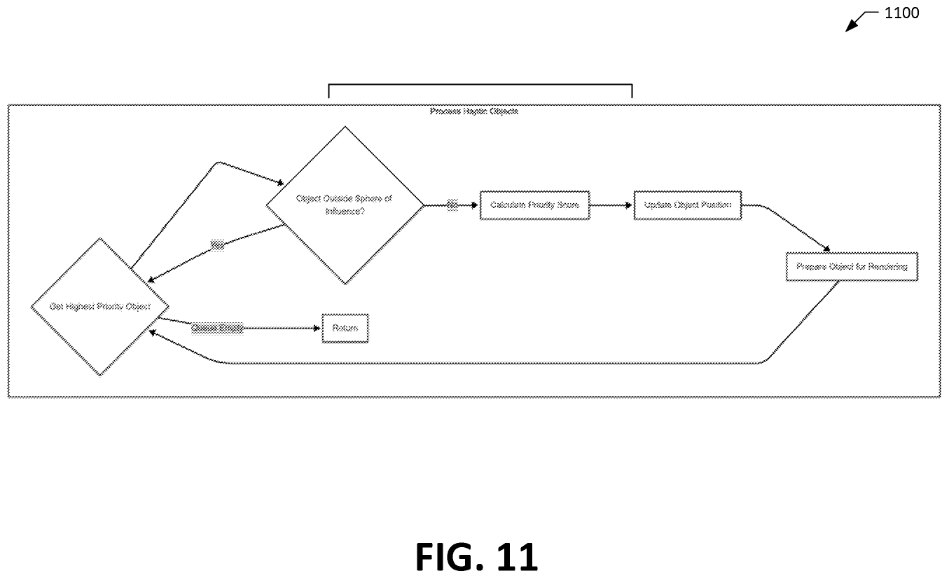

This FIG. 11 is a flowchart depicting a method 1100 in accordance with one or more example embodiments of the present disclosure. This is a multi-stage approach ensures that only the most relevant objects are processed, and among those, the most important ones are rendered first. This significantly improves the efficiency and responsiveness of haptic rendering, paving the way for more complex and immersive VR/AR experiences. The system is dynamic (priorities and sphere shapes change), adaptive (responds to user position and object movement/behavior), and object specific. This combination of features, specifically applied to object-level haptic rendering, is what distinguishes this approach from existing, less sophisticated methods.

In various embodiments, the initial haptic data object is comprised of the HapticObject class represents a single entity within the virtual environment that can potentially generate haptic feedback. It encapsulates the data and behavior related to an object's physical properties, its priority within the haptic rendering system, and its visual representation within the simulation. This data may include but is not limited to a unique identifier for the object (id), the objects position in the 2D virtual world (x, y), the base priority, the object's velocity, the priority score, the sphere of influence radius, color, and base radius.

In various embodiments, the unique identifier for the object is an integer. This is essential for efficiently updating objects within the priority queue. For example, 1, 2, 3 . . . (or a UUID string).

In various embodiments, the objects position in the 2D virtual world is defined by x and y. In a 3D system, this would be position (a 3D vector: x, y, z). For example, x=150.5, y=220.0.

In various embodiments, base priority is the inherent importance of the object, independent of its current position or velocity. This is a static property, set when the object is created. For example, s fast-moving bullet might have a base priority of 8.0, while a static wall might have a base priority of 2.0. This value influences the object's priority score regardless of other factors.

In various embodiments, the object's velocity is defined in components in the x and y directions. In 3D, this would be velocity (a 3D vector). For example, velocity_x=2.5, velocity_y=−1.0 (moving right and slightly up).

In various embodiments, the priority score is the objects current, dynamically calculated priority. This value changes as the object moves and interacts with the environment. This is the value used by the priority queue to order objects. For example, 10.2, 5.7, 1.3 (higher values are higher priority).

In various embodiments, the sphere of influence radius is the radius of the sphere of influence around the object. If the user's haptic interaction point is outside this sphere, the object is culled (not rendered haptically). For example, sphere_of_influence_radius=50.0 (meaning the object is culled if the user is more than 50 units away). This could be a constant or vary per object type.

In various embodiments, the color of the object is used for visualization in the simulation. This is not directly related to the haptic rendering itself, but it's helpful for debugging and demonstration. For example, color=(100, 100, 100) (gray).

In various embodiments, the base radius is defined a base or initial radius for the sphere of influence, specific to the object type. This value acts as a multiplier for the radius calculated from the attenuation formula. This value allows different object types to have inherently different influence ranges, even in the same medium. This is a constant value for a given object type, set during object creation. The value is not the final radius, but is a starting point.

For example:
#For a small, fast bullet:
base_radius=2.0//Small initial sphere
#For a large, slow-moving object:
base_radius=10.0//Larger initial sphere
#For a stationary, interactive object:
base_radius=5.0 #For an explosion:base_radius=8.0

In various embodiments, the base priority used for the object may be the priority used in MPEG haptics perception object, the priority used in the MPEG haptics channel object, or the priority used in the MPEG haptics band object of the MPEG haptics bitstream. Alternatively, in an embodiment, the base priority may be set based on the priority value used in the MPEG_scene_interactivity extension for the behavior parameter.

In various embodiments, a new priority value may be defined within the MPEG_scene_interactivity extension, the MPEG_haptic, or the MPEG_haptic_material extension called the base priority for haptics rendering.

In various embodiments, the volume of influence is based on the primitive type used for the interaction. For example, the primitive type may be comprised of a cuboid, plane region, cylinder region, capsule region, or spheroid.

In various embodiments, the HapticObject class may use the SPHEROID as the default primitive type and the corresponding radius defined for the spheroid primitive type may be used to calculate the volume of influence.

In an embodiment, new primitive types may be defined. For example, a sphere with elongation called Elongated_SPHERE. In an embodiment when the primitive type is elongated sphere then the radius of the sphere, the centroid of the sphere in 3D (x, y, z) coordinates and the elongation factor is defined. The elongation may be across the x-axis or along the y-axis or along the z-axis.

In various embodiments, the boundary attribute within the MPEG_scene_interactive.trigger.primitive defines the volume of influence of the haptic object. When the value of boundary attribute if zero, then all area of the primitive activates the proximity trigger. Otherwise, the region of intersection decreases following the normal direction of all sides of the primitive from its centroid. For the capsule primitive, the boundary attribute should be applied over the radius, top, and base attributes.

In various embodiments, the boundary attribute within the MPEG_scene_interactive.trigger.primitive may additionally contain the distance function type attribute. The distance function type determines the evaluation used for calculating the proximity factor.

In an example embodiment, the distance function type attribute may be comprised of an inverse function, sigmoid function, step function, linear function, or exponential function.

In an embodiment, the MPEG_scene_interactive.trigger may contain additional attributes called the proximity weight and the velocity weight which can take on the values between 0 and 1 and is used for the evaluation of priorities based on the proximity of the haptic object and the velocity at which the primitive may be interacting with the user in the scene.

In various embodiments, a new haptic object is initialized. For example, one example procedure for initializing a new haptic object follows:

```
PROCEDURE CONSTRUCTOR(id, x, y, base_priority, velocity_x, velocity_y)
  THIS.id = id
  THIS.x = x
  THIS.y = y
  THIS.base_priority = base_priority
  THIS.velocity_x = velocity_x
  THIS.velocity_y = velocity_y
  THIS.priority_score = 0 // Initial priority score
  THIS.base_radius : REAL // NEW: Base radius for this object type
    THIS.sphere_of_influence_radius = 50 // Or a value passed as an
argument
  THIS.color = (100, 100, 100) // Or a value passed as argument. THIS.type
= object_type // NEW: Object type (e.g., “STATIC”, “PROJECTILE”,
“EXPLOSION”)
  THIS.base_radius = 5.0 // NEW: Default base radius
  THIS.elongation_factor = 1.0 // NEW: Default elongation factor (no
elongation)
  THIS.time_since_explosion = 0 // NEW: For explosion objects.
  // --- Object-Type Specific Initialization ---
  IF THIS.type == “PROJECTILE” THEN
      THIS.base_radius = 2.0 // Smaller base radius for projectiles
      THIS.elongation_factor = 3.0 // Projectiles are elongated
  ELSE IF THIS.type == “EXPLOSION” THEN
      THIS.base_radius = 10.0
      THIS.explosion_expansion_factor = 0.5 // Example value, should be a
parameter of constructor.
  ELSE IF THIS.type == “STATIC” THEN // Example: Add a case for static
objects
      THIS.base_radius = 7.0 // Example value.
  END IF
  // Calculate the initial sphere of influence.
  CALCULATE_SPHERE_OF_INFLUENCE_RADIUS(THIS, environment) // Assuming
‘environment’ is globally accessible
END PROCEDURE
```

In various embodiments, the object's state (primarily its position) is updated based on its velocity, such as shown by the procedure below. This simulates the object's movement over time.

```
PROCEDURE UPDATE( )
  THIS.x = THIS.x + THIS.velocity_x // Update x position
  THIS.y = THIS.y + THIS.velocity_y // Update y position
  // Boundary checks (wrap-around in this example) IF THIS.x >
screen_width THEN THIS.x = 0 IF THIS.x < 0 THEN THIS.x = screen width IF
THIS.y > screen_height THEN THIS.y = 0 IF THIS.y < 0 THEN THIS.y =
screen_heightEND PROCEDURE
```

In various embodiments, the visual representation of the object is displayed on the screen, such as shown by the procedure below.

```
PROCEDURE DISPLAY(screen)
  // Draw a circle representing the object
  DRAW_CIRCLE(screen, THIS.color, (THIS.x, THIS.y), 10) // 10 is the radius
// Display the object's ID and priority score text = “ID: “ + THIS.id + ”,
P: “ + FORMAT(THIS.priority_score, ”.2f”) // Format to 2 decimal places
DRAW_TEXT(screen, text, (THIS.x, THIS.y + 20), black) // Draw text below the
objectEND PROCEDURE
```

In various embodiments, the procedure for one of which is depicted below, the object's priority score is calculated based on its distance to the user and its velocity.

```
PROCEDURE CALCULATE_PRIORITY_SCORE(user_x, user_y)
  // Calculate distance between user and object distance = SQRT((user_x −
THIS.x)\hat{ }2 + (user_y − THIS.y)\hat{ }2) // --- Get proximity parameters based on user
settings ---
  k, threshold =
GetProximityParameters(user_settings.proximity_sensitivity,
user_settings.distance_function_type)
  // --- Calculate proximity_factor based on the selected function ---
  IF user_settings.distance_function_type == “inverse” THEN
    proximity_factor = 1 / (1 + k * distance)
  ELSE IF user_settings.distance_function_type == “exponential” THEN
    proximity_factor = EXP(−k * distance)
  ELSE IF user_settings.distance_function_type == “sigmoid” THEN
    proximity_factor = 1 / (1 + EXP (k * (distance − threshold)))
  ELSE IF user_settings.distance_function_type == “linear” THEN
    proximity_factor = MAX(0, 1−(k*distance))
  ELSE IF user_settings.distance_function_type == “step” THEN
    IF distance <= threshold THEN
      proximity_factor = 1
    ELSE
      proximity_factor = 0
    ENDIF
  ELSE //Default
    proximity_factor = 1 / (1 + k * distance)
  ENDIF
        // --- Velocity Factor (Towards User) ---
  velocity_towards_user = DotProduct(Normalize(THIS.velocity),
Normalize(<user_x, user_y> − <THIS.x, THIS.y>))
  velocity_factor = MAX(0, velocity_towards_user / max_velocity)
  // --- NO Focus Factor in the invention ---
  // Calculate the final priority score
  THIS.priority_score = THIS.base_priority +
(proximity_weight * proximity_factor) +
(velocity_weight * velocity_factor)END PROCEDURE
```

In various embodiments, the HapticObject class is responsible for storing the object's data and updating its own state. The HapticObject class does not handle haptic rendering or priority queue management. This separation makes the code more modular and easier to maintain.

In various embodiments, the priority score is an attribute of the HapticObject, but the priority score is calculated by a separate method. This allows the priority to change dynamically based on the object's position and velocity relative to the user.

The Priority Queue class is embodied by the dynamic prioritization system. The Priority Queue responsible for maintaining a collection of HapticObject instances, ordering those objects based on their priority score, allowing for efficient updates to object priorities, and providing a method to retrieve (and remove) the highest-priority object.

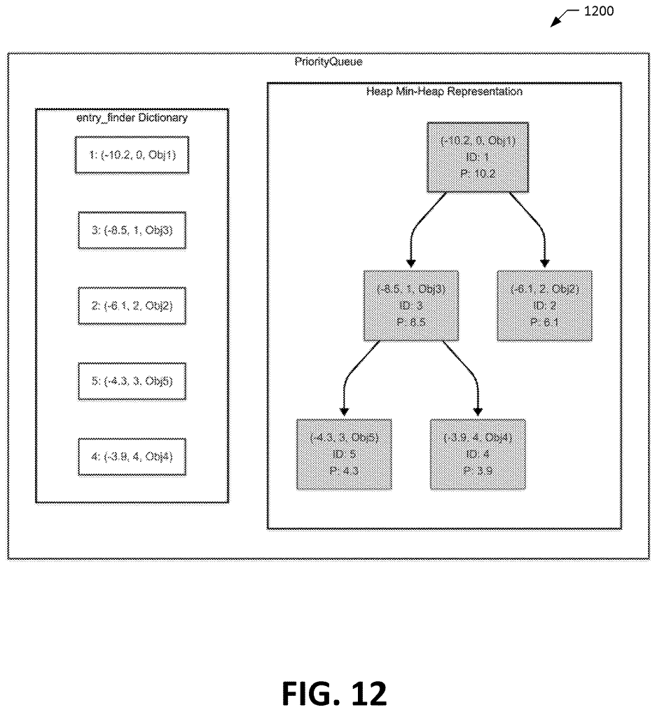

FIG. 12 depicts the priority queue architecture 1200 in accordance with one or more example embodiments of the present disclosure. The Priority Queue is implemented using a heap, specifically a min-heap. A heap is a tree-based data structure where the value of each node is less than or equal to the value of its children (min-heap). This ensures that the smallest element is always at the root of the tree. To achieve this with a min-heap, negative priority scores are stored. The object with the largest priority score will have the smallest negative priority score, and thus will be at the root of the min-heap. Heaps provide time complexity for insertion, deletion, and updating the priority of an existing element.

For example, initialization of an empty priority queue occurs, such as in accordance with the following procedure.

```
PROCEDURE CONSTRUCTOR( )
  THIS.heap = [ ] // Initialize an empty list
  THIS.entry_finder = { } // Initialize an empty dictionary
  THIS.REMOVED = “<removed-task>” THIS.counter = 0END PROCEDURE
```

New haptic objects are added to the queue or the priority of an existing object is updated, such as in accordance with the following procedure.

```
PROCEDURE ADD_OBJECT(haptic_object)
  IF haptic_object.id IS IN THIS.entry_finder THEN
    // Object already exists; remove the old entry
    REMOVE_OBJECT(haptic_object.id) END IF priority = −
haptic_object.priority_score // Use negative priority entry = (priority,
THIS.counter, haptic_object) // Use a counter for same priority.
THIS.counter = THIS.counter + 1; THIS.entry_finder[haptic_object.id] = entry
// Store the entry HEAP_PUSH(THIS.heap, entry) // Add to the heap (heapifies
automatically)END PROCEDURE
```

In accordance with the following procedure, objects are efficiently removed from the priority queue.

```
PROCEDURE REMOVE_OBJECT(object_id)
  entry = THIS.entry_finder[object_id] // Lookup the entry − O(1)
  REMOVE entry FROM THIS.entry_finder //O (1) entry.object = THIS.REMOVED
// Mark the object as removed // The heap itself is NOT modified at this
point.END PROCEDURE
```

The haptic object is removed and retuned with the highest priority, such as in accordance with the following procedure.

```
PROCEDURE GET_NEXT( )
  WHILE THIS.heap IS NOT EMPTY DO
    priority, count, haptic_object = HEAP_POP(THIS.heap) // Get the root
(min element)
    IF haptic_object IS NOT THIS.REMOVED THEN
      REMOVE haptic_object.id FROM THIS.entry_finder
      RETURN haptic_object // Found a valid object
    END IF
  END WHILE
  THROW EmptyQueueException // No valid objects found
END PROCEDURE
```

In accordance with the following procedure, the priority queue is reset to its empty state.

```
PROCEDURE CLEAR( )
  THIS.heap = [ ]
  THIS entry_finder = { }
  THIS.counter = 0END PROCEDURE
```

In various embodiments, the use of a heap provides logarithmic time complexity for key operations, making the priority queue efficient even with a large number of objects.

In various embodiments, the entry finder dictionary is crucial for efficiently updating object priorities. Without an entry finder dictionary, updating would require searching the entire heap. With entry finder the object's entry can be located in O(1) time, marked as REMOVED, and then added as a new entry with the updated priority.

In various embodiments, objects are not physically removed from the heap until they reach the top. This “lazy removal” is more efficient than re-heapifying the entire heap every time an object's priority changes.

In various embodiments, the sphere of influence is defined by a radius. This radius is not a fixed value but is calculated dynamically based on, medium properties, initial signal strength, and an attenuation threshold. The medium properties are the characteristics of the virtual medium (or media) between the user and the haptic object. This is represented by an attenuation factor (a). Initial Signal Strength is the initial strength of the haptic signal at the source (the object). The attenuation threshold is the minimum acceptable signal strength. When the attenuated signal falls below this threshold, the object is considered outside the sphere of influence.

In various embodiments, the sphere of influence represents the maximum distance at which a haptic object can potentially affect the user. Instead of using a fixed radius, the radius is calculated based on how quickly the haptic signal's energy dissipates as the haptic signal travels through the virtual environment. A higher attenuation factor means the signal weakens more rapidly with distance, resulting in a smaller sphere of influence. A lower attenuation factor means the signal travels further, resulting in a larger sphere.

In various embodiments, the Equation 1 is used to calculate the attenuation factor α.

$$α = \sqrt{\frac{γ \cdot ρ}{Y \cdot Z}} + {β}_{dir} \cdot cos ( θ ) , \qquad Eq . 1$$

In various embodiments, the variables needed to calculate the attenuation factor (α) are as follows, ρ is equal to a density of a medium, Y is equal to Young's Modulus (stiffness), Z is equal to an impedance, γ is equal to a damping coefficient, βdir is equal to a directional attenuation constant for the medium, and θ is equal to an angle of energy propagation relative to a medium's primary axis.

In various embodiments, the signal strength decays exponentially with distance, similar to how sound or light might attenuate. The attenuated signal strength (S_attenuated) is expressed in Equation 2.

$$S\_attenuated = S\_initial * exp ( - α * distance ) \qquad Eq . 2$$

The variables needed to calculate the attenuated signal strength defined in Equation 2 are as follows, S_attenuated is equal to the signal strength at a given distance, S_initial is equal to the initial signal strength at the object's location, a is equal to the attenuation factor, and distance is equal to the distance between the object and the user's haptic interaction point. This distance defines the sphere of influence radius, such as illustrated by the following example procedure.

// Inside the HapticObject class:
PROCEDURE CALCULATE_SPHERE_OF_INFLUENCE_RADIUS (environment)

| | |
|---|---|
| // 1. | Calculate the attenuation factor (α) using the provided formula. |
| // | This would involve getting the relevant medium properties (γ, ρ, Y, |

Z, β_dir, θ)

| | |
|---|---|
| // | from the ‘environment’ object. This is highly dependent on your |

specific

| | |
|---|---|
| // | implementation of the environment and how material properties are |

```
stored.
  medium_properties = GET_MEDIUM_PROPERTIES(THIS.position, environment) α
= SQRT(medium_properties.γ * medium_properties.ρ / (medium_roperties.Y *
medium_properties.Z)) + medium_properties.β_dir * COS(medium_properties.θ)
// 2. Calculate the radius based on initial strength and threshold. //
S_initial could be a property of the HapticObject, or it could be //
related to the object's base_priority. S_initial = THIS.base_priority *
initial_strength_factor // Example // S_threshold is a global constant or a
configurable parameter. IF α > 0 THEN // prevent division by zero.
radius = −LN(S_threshold / S_initial) / radius =
THIS.base_radius * radius // Scale by base_radius ELSE radius =
VERY_LARGE_NUMBER //Effectively infinite radius. END IF
  // --- Dynamic Adjustments (Examples) ---
  IF THIS.type == EXPLOSION THEN
    // Expand the radius over time, simulating a shockwave.
    radius = radius * (1 + explosion_expansion_factor *
time_since_explosion)
  END IF
      THIS.sphere_of_influence_radius = radius
  IF THIS.type == PROJECTILE THEN
    // Elongate the sphere in the direction of movement.
direction_vector = NORMALIZE(THIS.velocity) radius_x = radius * (1 +
elongation_factor * ABS(DOT_PRODUCT(direction_vector, <1,0,0>)))
    radius_y = radius * (1 + elongation_factor *
ABS(DOT_PRODUCT(direction_vector, <0,1,0>)))
    THIS.sphere_of_influence_radius = (radius_x, radius_y) // Store as a
tuple
  ELSE
    THIS.sphere_of_influence_radius = MAX(radius, minimum_radius)
  ENDIF
END PROCEDURE
//---In the initialization section
// Calculate and set the sphere of influence for each objectFOR EACH object IN
allHapticObjects DO object.CALCULATE_SPHERE_OF_INFLUENCE_RADIUS(environment)
priority_queue.add_object(object) END FOR
```

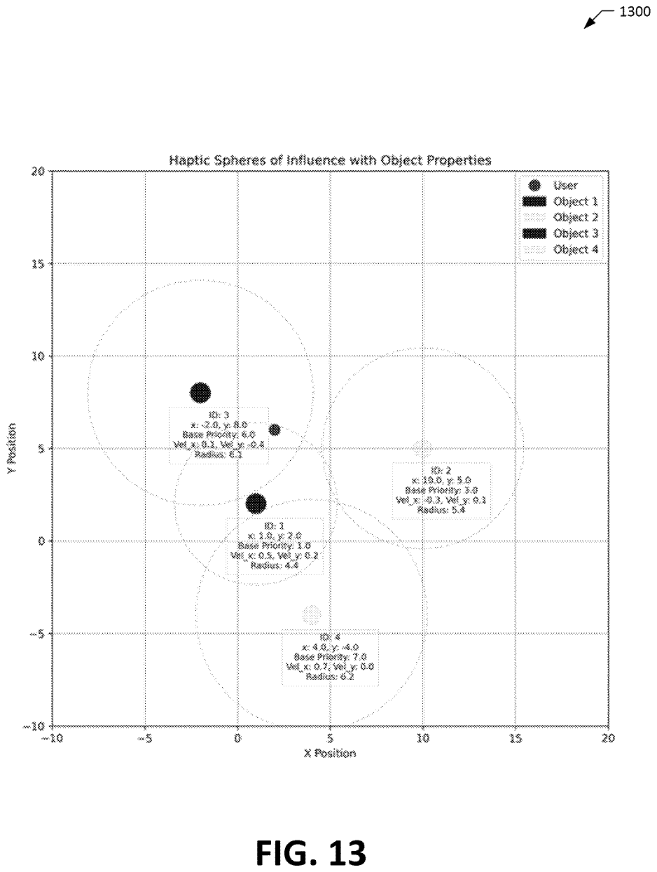

FIG. 13 depicts a sphere of influence in accordance with one or more example embodiments of the present disclosure. This diagram 1300 illustrates the sphere of influence concept in our haptic rendering algorithm. The red dot represents the user's haptic interaction point within the virtual environment. Each blue object represents a potential source of haptic feedback. The dotted circles surrounding the objects depict their respective spheres of influence, with the radius of each sphere dynamically calculated based on an attenuation factor (α). This attenuation factor, α, is derived from the formula shown, considering properties of the virtual medium. Because the blue object is considered active and provides haptic sensations, the user is currently located inside its sphere of influence. If the user were outside the sphere, the object would be considered inactive and culled, conserving processing resources.

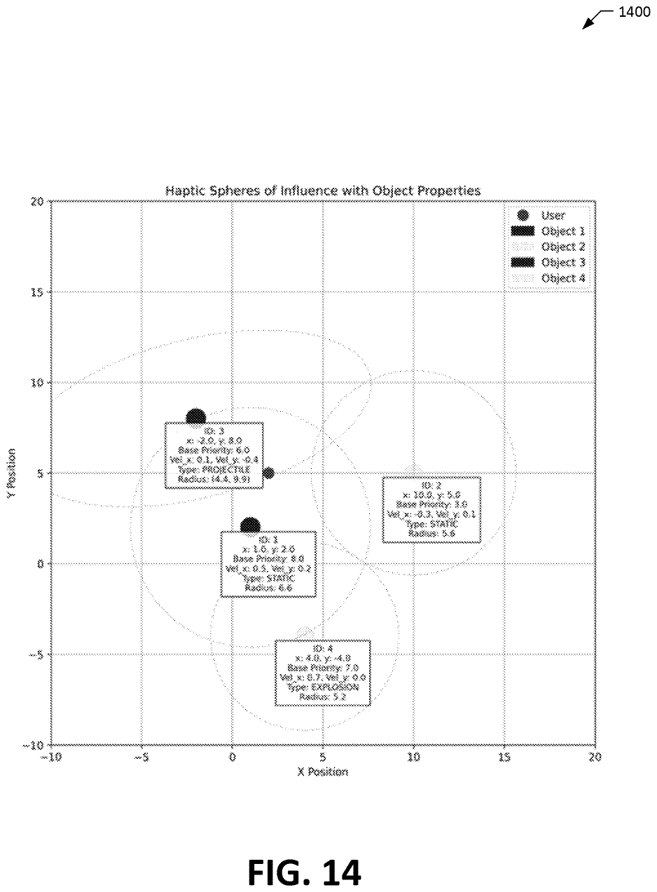

FIG. 14 depicts a dynamic sphere of influence in accordance with one or more example embodiments of the present disclosure. This diagram 1400 illustrates the dynamic sphere of influence concept in our haptic rendering algorithm. The red dot represents the user's haptic interaction point (e.g., hand position) within the 2D virtual environment. Each blue-filled circle represents a haptic object, capable of generating tactile feedback. The dashed circles or ellipses surrounding the objects depict their respective spheres of influence. The size and shape of each sphere are dynamically calculated: objects of type ‘PROJECTILE’ have their spheres of influence elongated into ellipsoids along their direction of motion, while ‘EXPLOSION’ type objects might have dynamically expanding spheres (not shown in this static snapshot). ‘STATIC’ objects have standard circular spheres. The radius (or radii, for ellipsoids) is determined based on an attenuation factor (α), the object's base priority, and object-specific parameters. The attenuation factor α, shown in the subtitle, is calculated using the formula derived from material properties. Objects are considered ‘active’ for haptic rendering only when the user's haptic interaction point lies inside their sphere of influence; otherwise, they are culled to conserve computational resources. The text near each object displays its ID, coordinates (x, y), base priority, velocity components (Vel_x, Vel_y), type, and the calculated radius (or radii, for projectiles) of its sphere of influence.

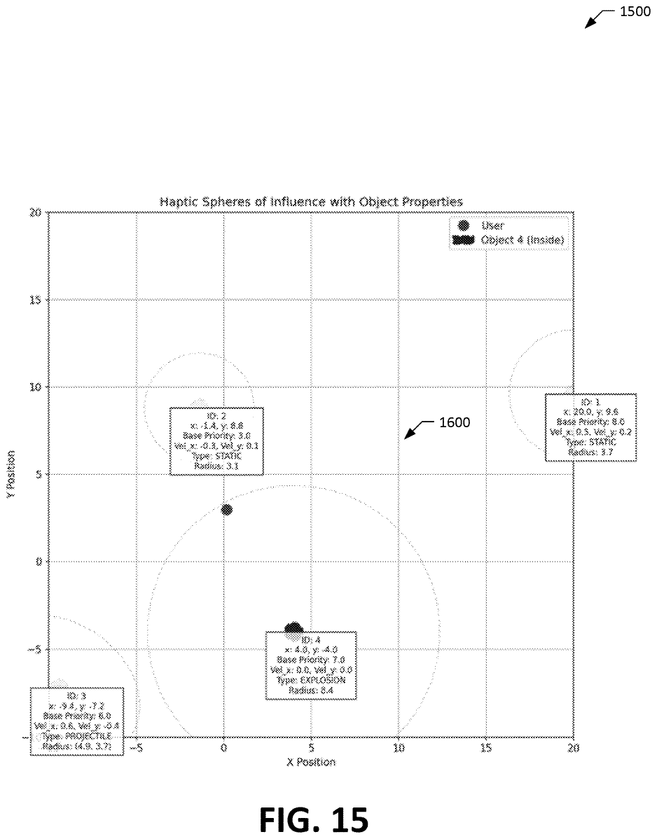

FIG. 15 depicts a first point in time for a real-time haptic rending system that prioritizes haptic feedback based on a dynamic sphere of influence around the user in accordance with one or more example embodiments of the present disclosure. The diagram 1500 depicts a first point in time for a real-time haptic rendering system that prioritizes haptic feedback based on a dynamic “sphere of influence” (SOI) around the user. Objects outside this SOI are culled (ignored), while those inside have their priority calculated. The system updates object positions and recalculates the SOIs, which are ellipsoidal for projectiles (elongated in the direction of motion) and expanding over time for explosions. Haptic feedback is then rendered for the highest-priority object within the user's SOI. The animation shows objects moving, their SOIs changing shape and size, and the user's haptic interaction with them, highlighting which objects provide feedback at any given time based on proximity and priority. The GIF showcases the core components of the process: object position updates, dynamic SOI checks (including ellipsoidal and expanding SOIs), and priority-based selection for haptic feedback.

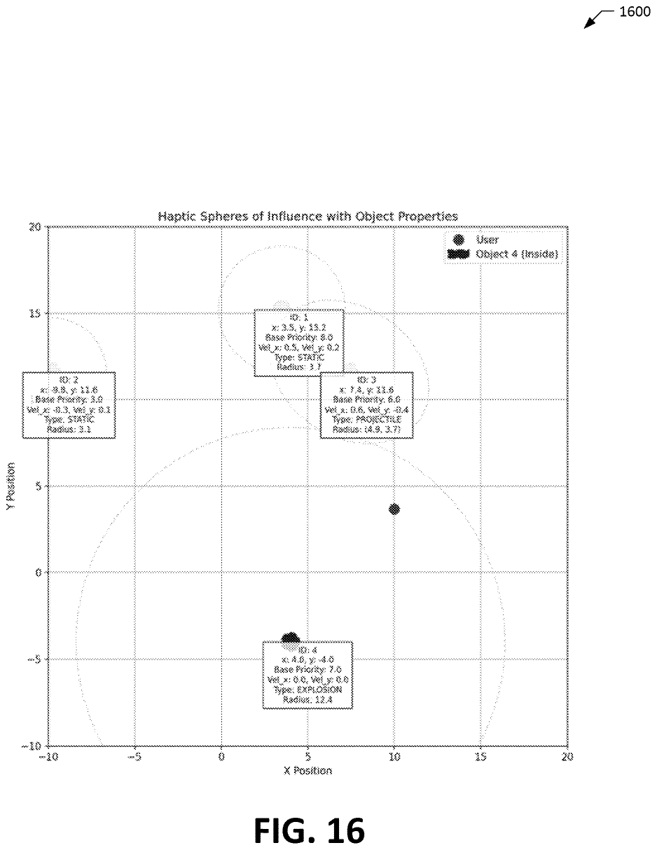

FIG. 16 depicts a second point in time for a real-time haptic rending system that prioritizes haptic feedback based on a dynamic sphere of influence around the user in accordance with one or more example embodiments of the present disclosure. The diagram 1600 depicts a second point in time for a real-time haptic rending system that priorities haptic feedback based on a dynamic sphere of influence around the user.

The pseudocode to calculate the radius of the sphere of influence in accordance with an example embodiment is defined as:

// Inside the HapticObject class:
PROCEDURE CALCULATE_SPHERE_OF_INFLUENCE_RADIUS (environment)

| | |
|---|---|
| // 1. | Calculate the attenuation factor (α) using the provided formula. |
| // | This would involve getting the relevant medium properties (γ, ρ, Y, |

Z, β_dir, θ)

| | |
|---|---|
| // | from the ‘environment’ object. This is highly dependent on your |

specific

| | |
|---|---|
| // | implementation of the environment and how material properties are |

```
stored. medium properties = GET_MEDIUM_PROPERTIES(THIS.position,
environment) α = SQRT (medium_properties.γ * medium_properties.ρ /
(medium_properties.Y * medium_properties.Z)) + medium_properties.β_dir *
COS(medium_properties.θ) // 2. Calculate the radius based on initial
strength and threshold. // S_initial could be a property of the
HapticObject, or it could be // related to the object's base_priority.
S_initial = THIS.base_priority * initial_strength_factor // Example //
S_threshold is a global constant or a configurable parameter. IF α > 0 THEN
// prevent division by zero. radius = −LN(S_threshold / S_initial) / α
radius = THIS.base_radius * radius // Scale by base_radius ELSE
radius = VERY_LARGE_NUMBER //Effectively infinite radius. END IF
  // --- Dynamic Adjustments (Examples) ---
  IF THIS.type == EXPLOSION THEN
  // Expand the radius over time, simulating a shockwave.
    radius = radius * (1 + explosion_expansion_factor *
time_since_explosion)
  END IF
      THIS.sphere_of_influence_radius = radius
  IF THIS.type == PROJECTILE THEN
    // Elongate the sphere in the direction of movement.
    direction_vector = NORMALIZE(THIS.velocity) radius_x = radius *
(1 + elongation_factor * ABS(DOT_PRODUCT(direction_vector, <1,0,0>)))
    radius_y = radius * (1 + elongation factor *
ABS(DOT_PRODUCT(direction_vector, <0,1,0>)))
    THIS.sphere_of_influence_radius = (radius_x, radius_y) // Store as a
tuple
  ELSE
    THIS.sphere_of_influence_radius = MAX(radius, minimum_radius)
  ENDIF
END PROCEDURE
//---In the initialization section
// Calculate and set the sphere of influence for each objectFOR EACH object IN
allHapticObjects DO object. CALCULATE_SPHERE_OF_INFLUENCE_RADIUS(environment)
priority_queue.add_object(object)END FOR
```

The pseudocode defines how to calculate the sphere of influence radius. This is a new method added to the HapticObject class. In various embodiments, the method includes obtaining medium properties. In various embodiments, obtaining the medium properties includes the relevant material properties (γ, ρ, Y, Z, β_dir, θ) for an object's position. This might involve a simple case or a complex case. In the simple case, if the entire environment has uniform properties, the function of obtaining medium properties returns constant values. In the complex case, if you have different materials in different regions, the function of obtaining the medium properties might need to perform a spatial query (e.g., using an octree or other spatial data structure) to determine which material the object is currently in.

In various embodiments, the method may further include calculating the attenuation factor α using Equation 1 defined above. In various embodiments, the method may further include calculating the initial signal strength (S_initial). In various embodiments, the initial signal strength may be proportional to base priority. In various embodiments, the method may further include determining a signal threshold, S_threshold. This is a constant value representing the minimum perceptible haptic signal strength that is determined through experimentation. In various embodiments, the method may further include calculating the radius for the sphere of influence. The formula distance=−ln(S_threshold/S_initial)/α is used to calculate the radius. The natural logarithm (ln) is used because exponential decay is assumed. This base radius is then further modified based on object type and dynamic properties. In various embodiments, a minimum radius is determined. The minimum radius prevents the radius from being equal to zero. A minimum radius can be enforced to ensure that objects always have some haptic influence.

In various embodiments, the method may further include dynamic adjustments including an object type check. The object type check ensures that the object's type attribute is correct. The object type attribute may include an explosion or a projectile. If the object is an explosion, the radius is dynamically expanded over time, simulating a shockwave: radius=radius*(1+explosion_expansion_factor*time_since_explosion). If the object is a projectile, the sphere of influence is elongated into an ellipsoid in the direction of the object's velocity. The radii along the x, y axes (radius_x, radius_y) are calculated based on an elongation factor and the dot product of the object's normalized velocity vector with the cardinal axes. The sphere of influence radius attribute is then stored as a tuple/vector: (radius_x, radius_y). In various embodiments, if the object type is a projectile, the ellipsoidal distance calculation is used. The ellipsoidal distance calculation is a utility function used in conjunction with the sphere of Influence. The pseudocode for this calculation is defined in one example embodiment as follows:

```
FUNCTION CalculateEllipsoidDistance(point, center, radii)
  // Normalize the point's coordinates by the ellipsoid's radii
  normalized_x = (point.x − center.x) / radii.x
  normalized_y = (point.y − center.y) / radii.y
  // Calculate the Euclidean distance in the normalized space
  normalized_distance = SQRT(normalized_x\hat{ }2 + normalized y\hat{ }2) // If the
normalized_distance is greater than 1, the point is outside IF
normalized_distance > 1 THEN RETURN normalized_distance // Outside the
ellipsoid. ELSE RETURN 0 // Inside the ellipsoid ENDIFEND FUNCTION
```

For other object types, the base radius is used, potentially with a minimum radius enforced.

The above method for calculating the sphere of influence radius is called during the initialization phase, after the objects are created but before they are added to the priority queue. This timing ensures that each object has its sphere of influence calculated based on its initial position and the surrounding environment. For objects with dynamic spheres of influence (e.g., explosions), the method for calculating the sphere of influence radius could be called periodically (e.g., every frame or every few frames) to update the radius. In various embodiments the radius is updated incrementally within the object's update( ) method (e.g., increasing time_since_explosion and recalculating the radius based on that). For projectiles, the sphere is calculated once upon creation, but its shape is determined by the initial velocity.

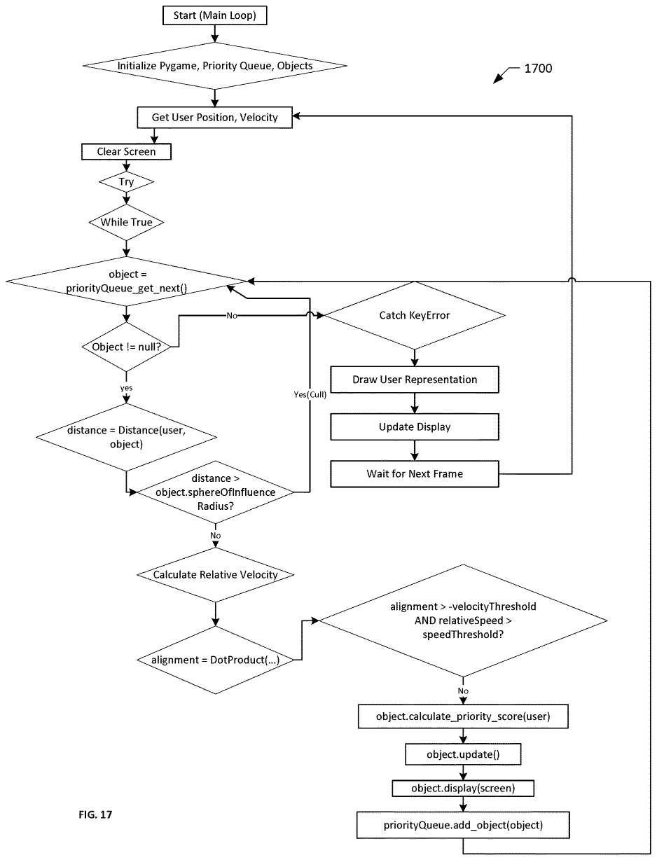

FIG. 17 is a flowchart depicting a method 1700 in accordance with one or more example embodiments of the present disclosure. The main loop is the core of the haptic rendering algorithm. The main loop runs continuously, typically once per frame of the VR/AR application or game. Each iteration of the loop performs a series of steps. In various embodiments, the iteration of the loop performs initialization. Initialization includes, creating a priority queue, creating initial haptic data objects, calculating the initial sphere of influence, and adding objects to the queue. In various embodiments, the Priority Queue object is instantiated. This sets up the heap data structure that will manage the haptic objects. In various embodiments, the initial haptic data objects are created. HapticObject instances are created, representing the initial set of haptic objects in the scene. Their positions, velocities, base priorities, and sphere of influence radii are set. In various embodiments, the initial sphere of influence is calculated. In various embodiments, the initial haptic data objects are added to the priority queue. Their initial priority score values (calculated based on base priority, initial distance, and velocity) determine their initial positions in the queue.

In various embodiments, the iteration of the loop performs event handling. The loop checks for any user input events (e.g., keyboard presses, mouse movements, controller input) or system events (e.g., window close request). In various embodiments, the primary event is updating the user's position based on mouse movement (simulating hand tracking). In a real VR/AR application, this may involve getting data from the tracking system. In various embodiments, the current position of the user's haptic interaction point (e.g., the virtual hand) is obtained. In various embodiments, this is simply the mouse cursor position. In various embodiments, the previous frame's rendering is cleared, preparing for drawing the updated scene.

In various embodiments, the iteration of the loop performs Haptic Object Processing as an inner loop. In various embodiments, this inner loop handles the priority queue processing. In various embodiments, an error will occur if the priority queue is empty. This is the normal way the inner loop terminates each frame. This inner loop continues as long as there are objects in the priority queue. In various embodiments, the object with the highest priority (lowest negative score) is retrieved from the priority queue and removed from the queue.

In various embodiments, the distance between the user's haptic interaction point and the object's position is calculated. In various embodiments, in an instance in which the distance is outside of a dynamic sphere of influence for the initial haptic data object or in which the distance is increasing at a rate greater than a threshold rate, the haptic object is culled. In various embodiments, the distance is greater than the object's sphere of influence radius and the object is considered too far away to be felt. If the object is culled, the continue statement skips the rest of the inner loop's body and proceeds to the next object in the queue.

In various embodiments, in an instance where the distance is within the dynamic sphere of influence for the initial haptic data object, a priority score of the initial haptic data object is updated with an updated priority score and updated in the priority queue. The object's priority score is recalculated based on its current position, velocity, and the user's position. In various embodiments, the object's position is updated based on its velocity. Updating the priority score in the priority queue allows the object's position in the queue to change dynamically based on its new priority.

In various embodiments, after processing all objects in the priority queue, the user's representation is drawn on the screen. In various embodiments, the changes made to the screen (drawing objects, the user representation) are displayed. In various embodiments, the loop waits for a short time to maintain a consistent frame rate (e.g., 60 frames per second). This delay prevents the simulation from running too fast. The pseudocode for one example of this process is defined as:

```
PROCEDURE MAIN_LOOP( )
  INITIALIZE Pygame // Or your graphics library
  CREATE priority_queue
  CREATE initial_haptic_objects
  FOR EACH object IN initial_haptic_objects DO
    object.CALCULATE_SPHERE_OF_INFLUENCE_RADIUS(environment) // Calculate
initial sphere
    ADD_OBJECT(priority_queue, object) // Add to the queue
  END FOR
  user_position = initial_user_position // Set initial user position
  WHILE application is running DO // --- Event Handling --- FOR
EACH event IN GET_EVENTS( ) DO IF event.type IS QUIT_EVENT THEN
application_is_running = FALSE // Exit the main loop END IF
END FOR // --- Get User Input --- user_position =
GET_CURRENT_USER_POSITION( ) // Get mouse/hand position // --- Haptic
Rendering Logic --- CLEAR_SCREEN( ) TRY WHILE TRUE DO
// Process objects until priority queue is empty current_object
= GET_NEXT(priority_queue) // --- Culling (Sphere of Influence)
--- IF THIS.type == PROJECTILE THEN
          distance = CalculateEllipsoidDistance(user_position,
current_object.position, current_object.sphere_of_influence_radius) // new
function to calculate distance from an ellipsoid
      ELSE
            distance = EuclideanDistance(user_position,
current_object.position)
      ENDIF
      IF distance > current_object.sphere_of_influence_radius THEN
//This will be overloaded based on sphere or elipsoid.
            CONTINUE // Skip to the next object; don't re-add =
culled.
      END IF
            // --- NEW: Velocity-Based Culling ---
      relative_velocity = object.velocity − user.velocity //
Calculate relative velocity
      relative_speed = Length(relative_velocity) //
Magnitude of relative velocity
      direction_vector = Normalize(object.position − user.position)
// Vector from user TO object
      alignment = DotProduct(Normalize(relative_velocity),
direction_vector) // Dot product
      IF alignment < −velocity_culling_threshold AND relative_speed >
velocity_culling_speed_threshold THEN
            CONTINUE // Cull: Object is moving *away* from the user
*quickly*
      END IF
      // --- Update Object State and Priority ---
      CALCULATE_PRIORITY_SCORE(current_object, user_position) //
Update priority
      UPDATE(current_object) // Update object position
      // --- Visual Representation (for simulation ONLY) ---
      DISPLAY(current_object)
      // --- Re-insert into Priority Queue ---
ADD_OBJECT(priority_queue, current_object) // Re-add with *updated* priority
END WHILE CATCH EmptyQueueException: // The priority queue is
empty for this frame. This is expected. PASS // Do nothing;
continue to the next frame END TRY // --- Draw User
Representation --- DRAW_USER_REPRESENTATION(user_position) // ---
Update Display (for simulation ONLY) --- UPDATE_DISPLAY( ) // Refresh the
screen WAIT_FOR_NEXT_FRAME( ) // Control frame rate END WHILE
CLEANUP( )END PROCEDURE
```

In various embodiments, the velocity of the object relative to the user. This is calculated by subtracting the user's velocity from the object's velocity. This assumes that you have access to the user's velocity (which might be the hand velocity, head velocity, or a combination). If the user is stationary, relative velocity is simply the object's velocity. In various embodiments, the magnitude (speed) of the relative velocity vector. In various embodiments, the normalized (unit-length) vector pointing from the user's position to the object's position. This defines the “line of sight” from the user to the object. In various embodiments, the dot product of the normalized relative velocity and the direction vector. This is the key to the directional culling. In various embodiments, if alignment is greater than zero, the object is moving towards the user (positive dot product). If the alignment is equal to zero, the object is moving perpendicular to the user. If the alignment is less than zero, the object is moving away from the user (negative dot product).

In various embodiments, the velocity culling threshold (REAL) is a constant value (e.g., −0.7). This determines how directly the object needs to be moving away from the user to be culled. A value of −1.0 would mean only objects moving directly away would be culled. A value of 0.0 would mean any object with any component of its velocity directed away from the user would be culled. Values between −1 and 0 allow for some tolerance.

In various embodiments, velocity culling speed threshold (REAL) is a constant value (e.g., 2.0). This determines how fast the object needs to be moving away to be culled. This prevents slow-moving objects from being culled just because they happen to be moving slightly away from the user.

In a split rendering scenario, where the haptics priority culling can be done at the SRS or SRC, the split rendering configuration message can have a hapticsPriorityCulling field that indicates if the client is capable of priority culling. In an embodiment, the field is a BOOLEAN, which if TRUE indicates that the server will do the priority culling and if FALSE indicates that the client will do the priority culling. In an embodiment where the server does the priority culling, the pose and action message of the user and other devices sent from the SRC to the SRS additionally includes one or more of a velocity, direction vector and acceleration to be used for determining the priority score of the relevant objects.

In an embodiment, the UE sends the user settings to be used for determining the sphere of influence as a message over the data channel to the SRS, including one or more of a proximity sensitivity and a distance function type.

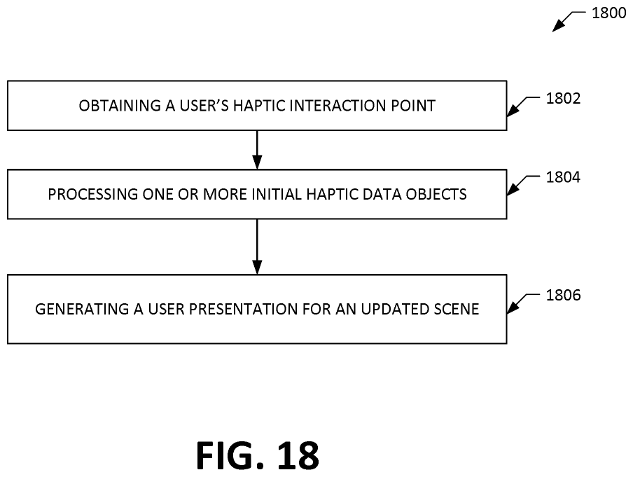

FIG. 18 illustrates another flowchart illustrating a method 1800, such as by the apparatus 800 of FIG. 8, in accordance with one or more example embodiments of the present disclosure. As shown in block 1802 of FIG. 18, the apparatus 800 includes means, such as the processor 805, the user interface 808 or the like, configured to obtain a user's haptic interaction point. As shown in block 1804 of FIG. 18, the apparatus 800 includes means, such as the processor 805, or the like, for processing one or more initial haptic data objects. As shown in block 1806 of FIG. 18, the apparatus 800 includes means, such as the processor 805, the user interface 808 or the like, for generating a user presentation for an updated scene.

The apparatus 800, such as the processor 805, is configured to process one or more initial haptic data objects by receiving an initial haptic data object from a priority queue and determining a distance between the user's haptic interaction point and the initial haptic data object. In an instance in which the distance is outside of a dynamic sphere of influence for the initial haptic data object or in which the distance is increasing at a rate greater than a threshold rate, the haptic object is culled. Alternatively, in an instance where the distance is within the dynamic sphere of influence for the initial haptic data object, a priority score of the initial haptic data object is updated with an updated priority score and updated in the priority queue. Each initial haptic data object may represent a single entity with a virtual environment that is able to generate haptic feedback. For example, the initial haptic data object may encapsulate data and behavior related to one or more haptic object's physical properties, its priorities and its visual representation within a simulation. The priority queue may be implemented as a heap, such as a mini-heap that ma include a tree-based data structure defined by a plurality of nodes. A respective node of the plurality of nodes may include or represent a value that is less than or equal to a value of children nodes of the respective node.

In an example embodiment, the apparatus 800 also includes means, such as the at least one processor 805 or the like, for initializing an iterative haptic signal mediation loop for a scene within an application by generating an initial haptic data object for respective haptic objects of one or more haptic objects in a scene and adding the initial haptic data object to a priority queue based on the priority score. In this embodiment, the initial haptic data object has attributes including a priority score and a dynamic sphere of influence.

In an example embodiment, the initial haptic data objects in the priority queue are retrieved from highest priority to lowest priority. For example, the highest priority may correspond to a lowest negative score. The priority score of an example embodiment is calculate based on a velocity factor, such as the velocity towards a user; a proximity factor that uses, for example, a non-linear function, e.g., an inverse-distance, exponential decay function, or sigmoidal function; and a base priority determined from a scene description. The base priority may be defined by an importance of the object. The base priority may be a static property that is set when the object is created. In an example embodiment, the base priority that is used for the one or more haptic objects is at least one of a priority of a movie picture experts group (MPEG) haptics perception object, a priority of a MPEG haptics channel object, a priority of a MPEG haptics band object of a MPEG haptics bitstream, or a priority that is set based on a priority value used in a MPEG_scene_interactivity extension for a behavior parameter.

In an example embodiment, the dynamic sphere of influence is defined by a base radius around the haptic object. For example, the dynamic sphere of influence may be object-type dependent. In this embodiment, the object-type dependent dynamic sphere of influence includes a dynamically adjusted radius. The base radius may serve as a multiplier for the dynamically adjusted radius. For example, the dynamically adjusted radius may be adjusted by an attenuation factor comprising

$$α = \sqrt{\frac{γ \cdot ρ}{Y \cdot Z}} + {β}_{dir} \cdot cos ( θ ) ,$$

wherein ρ is equal to a density of a medium, Y is equal to Young's Modulus (stiffness), Z is equal to an impedance, γ is equal to a damping coefficient, βdir is equal to a directional attenuation constant for the medium, and θ is equal to an angle of energy propagation relative to a medium's primary axis. A higher attenuation factor results in a smaller sphere of influence and a lower attenuation factor results in a larger sphere. In an example embodiment, the dynamically adjusted radius includes an expanding sphere or an elongated sphere. The dynamic sphere of influence may include a volume of influence that is defined by a boundary attribute comprised of a distance function type attribute, such as at least one of an inverse, sigmoid, step, linear, or exponential type function. The volume of influence may be based on a primitive type for an interaction, such as at least one of cuboid, plane region, cylinder region, capsule region, spheroid, and elongated sphere.

In an example embodiment, the dynamic sphere of influence allows for velocity-based culling. For example, the velocity-based culling is applied to objects that are within the sphere of influence but moving away from the user at a velocity greater than a velocity threshold.

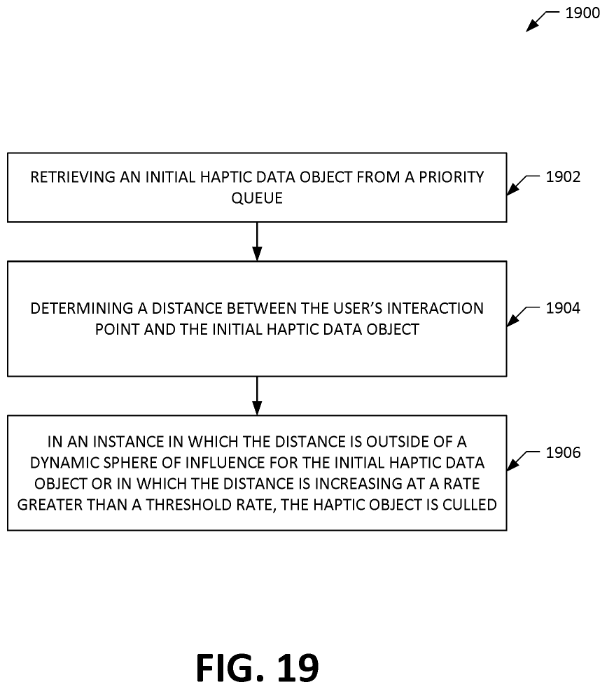

FIG. 19 illustrates another flowchart illustrating a method 1900, such as by the apparatus 800 of FIG. 8, in accordance with one or more example embodiments of the present disclosure. As described in conjunction with FIG. 18, the apparatus includes means, such as the processor 805, or the like, for processing one or more initial haptic data objects. As shown in block 1902 of FIG. 19, the apparatus 800 includes means, such as the processor 805, or the like, for retrieving an initial haptic data object from the priority queue as a part of processing the one or more initial haptic data objects. As shown in block 1904 of FIG. 19, the apparatus 800 includes means, such as the processor 805, or the like, for determining a distance between the user's haptic interaction point and the initial haptic data object. As shown in block 1906 of FIG. 19, in an instance in which the distance is outside the dynamic sphere of influence for the initial haptic data object or in which the distance is increasing at a rate greater than a threshold rate, the apparatus 800 includes means, such as the processor 805, or the like, for culling the haptic object.

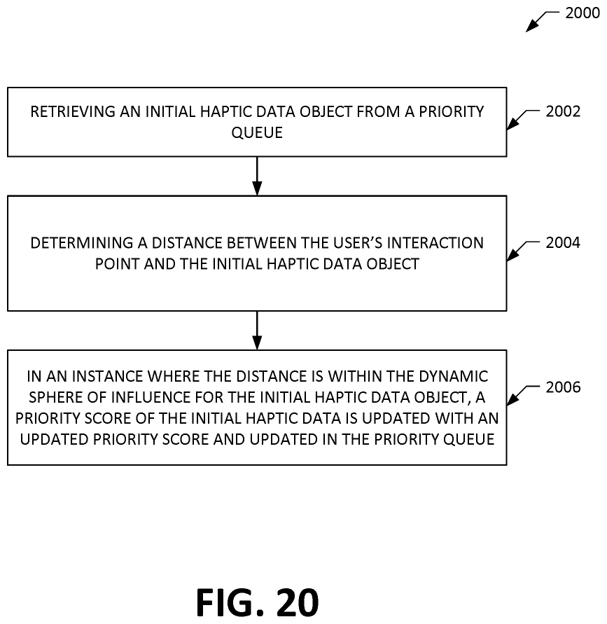

FIG. 20 illustrates another flowchart illustrating a method 2000, such as by the apparatus 800 of FIG. 8, in accordance with one or more example embodiments of the present disclosure. As described in FIG. 18, the apparatus includes means, such as the processor 805, or the like, for processing one or more initial haptic data objects. As shown in block 2002 of FIG. 20, the apparatus 800 includes means, such as the processor 805, or the like, for retrieving an initial haptic data object from the priority queue as a part of processing the one or more initial haptic data objects. As shown in block 2004 of FIG. 20, the apparatus 800 includes means, such as the processor 805, or the like, for determining a distance between the user's haptic interaction point and the initial haptic data object. As shown in block 2006 of FIG. 20, in an instance where the distance is within the dynamic sphere of influence for the initial haptic data object, the apparatus 800 includes means, such as the processor 805, or the like, for updating a priority score of the initial haptic data with an updated priority score that, in turn, is updated in the priority queue.

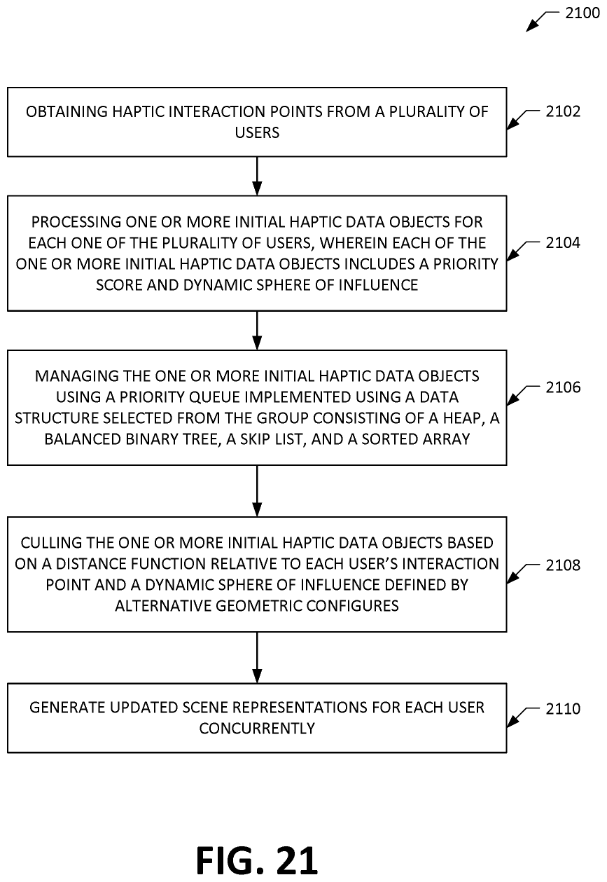

FIG. 21 illustrates another flowchart illustrating a method 2100, such as by the apparatus 800 of FIG. 8, in accordance with one or more example embodiments of the present disclosure. As shown in block 2102 of FIG. 21, the apparatus 800 includes means, such as the processor 805, the user interface 808 or the like, for obtaining haptic interaction points from a plurality of users. As shown in block 2104 of FIG. 21, the apparatus 800 includes means, such as the processor 805, or the like, for processing one or more initial haptic data objects for each one of the plurality of users. In one or more embodiments, each of the one or more initial haptic data objects includes a priority score and a dynamic sphere of influence. As shown in block 2106 of FIG. 21, the apparatus 800 includes means, such as the processor 805, or the like, for managing the one or more initial haptic data objects using a priority queue implemented using a data structure selected form the group consisting of a heap, a balanced binary tree, a skip list, and a sorted array. As shown in block 2108 of FIG. 21, the apparatus 800 includes means, such as the processor 805, or the like, for culling the one or more initial haptic data objects based on a distance function relative to each user's interaction point and a dynamic sphere of influence defined by alternative geometric configurations. As shown in block 2110 of FIG. 21, the apparatus 800 includes means, such as the processor 805, or the like, for generating updated scene representations for each user concurrently.

In an example embodiment, the one or more geometric configurations are dynamic adjustments. For example, the dynamic adjustments may include dynamically varying dimensions of the geometric configuration based on an object type and an attenuation factor. In an example embodiment, the apparatus 800 also includes means, such as the processor 805 or the like, for synchronizing haptic rendering across the plurality of users by periodically aligning spatial coordinate frames and interaction timestamps to ensure consistent haptic feedback across the multi-user environment.

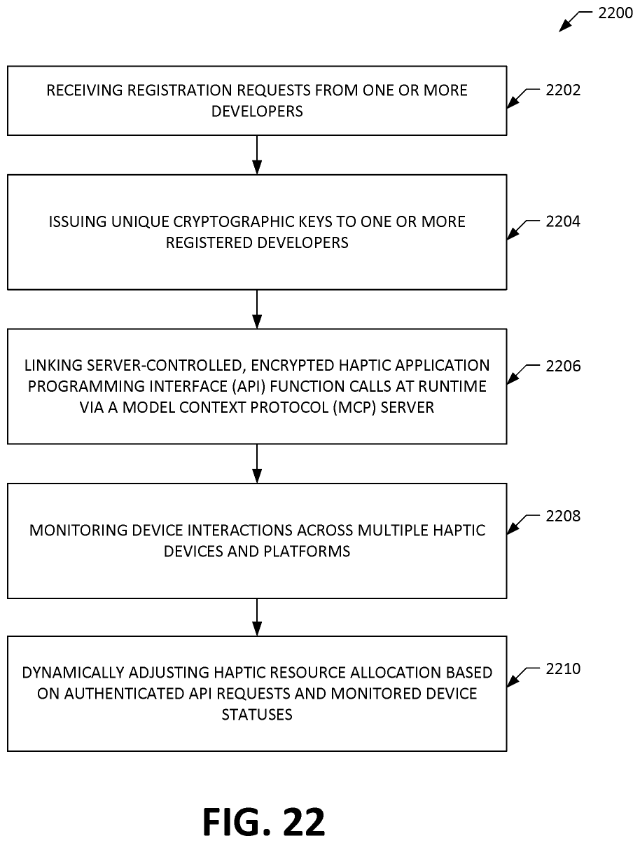

FIG. 22 illustrates another flowchart illustrating a method 2200, such as by the apparatus 800 of FIG. 8, in accordance with one or more example embodiments of the present disclosure. As shown in block 2202 of FIG. 22, the apparatus 800 includes means, such as the processor 805, the user interface 808, the radio interface 806 or the like, for receiving registration request from one or more developers. As shown in block 2204 of FIG. 22, the apparatus 800 includes means, such as the processor 805, or the like, for issuing unique cryptographic keys to one or more registered developers. As shown in block 2206 of FIG. 22, the apparatus 800 includes means, such as the processor 805, or the like, for linking server-controlled, encrypted haptic application programming interface (API) function calls at runtime via a model context protocol (MCP) server. As shown in block 2208 of FIG. 22, the apparatus 800 includes means, such as the processor 805, the radio interface 806 or the like, for monitoring device interactions across multiple haptic devices and platforms. As shown in block 2210 of FIG. 22, the apparatus 800 includes means, such as the processor 805, or the like, for dynamically adjusting haptic resource allocation based on authenticated API requests and monitored device statuses.

In an example embodiment, the MCP server integrates with multiple haptic hardware manufacturers and development platforms, and the server enforces licensing and device-specific interaction monitoring by logging API requests, tracking device-specific interactions, and dynamically linking encrypted haptic API function calls at runtime. The apparatus 800 of an example embodiment also includes means, such as the processor 805 or the like, for employing AI-driven algorithms to analyze real-time API usage, detect unauthorized access or modification attempts, and trigger forensic logging with cryptographically hashed and timestamped records. In an example embodiment, the apparatus 800 further includes means, such as the processor 805 or the like, for detecting and revoking API access upon identification of suspicious API usage or attempts to modify priority queue behavior. The device interactions may happen in real-time.

As described above, FIGS. 18-22 are flowcharts of various methods that can be carried out by, e.g., the apparatus 800, and/or according to a computer program product, according to an example embodiment of the disclosure. A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as, e.g., in conjunction with the flowcharts of FIGS. 18-22. Accordingly, blocks of the flowcharts support combinations of means for performing the specified functions and combinations of operations for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

In some embodiments, certain ones of the operations above may be modified or further amplified. Furthermore, in some embodiments, additional optional operations may be included. Modifications, additions, or amplifications to the operations above may be performed in any order and in any combination. Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments presented herein and that modifications and other embodiments are intended to be included within the scope of the appended claims. Although specific terms are employed herein, they are used in a generic and descriptive sense only and not for purposes of limitation.

What is claimed:

1. An apparatus for real-time spatial haptic rendering comprising:
at least one processor; and
at least one memory storing instructions that, when executed by the at least one processor, cause the apparatus to:
obtain a user's haptic interaction point;
process one or more initial haptic data objects wherein processing one of the initial haptic data object comprises:
retrieve an initial haptic data object from a priority queue; and
determine a distance between the user's haptic interaction point and the initial haptic data object,
wherein, in an instance in which the distance is outside of a dynamic sphere of influence for the initial haptic data object or in which the distance is increasing at a rate greater than a threshold rate, the haptic object is culled,
wherein, in an instance where the distance is within the dynamic sphere of influence for the initial haptic data object, a priority score of the initial haptic data object is updated with an updated priority score and updated in the priority queue; and
generate a user representation for an updated scene.

2. The apparatus of claim 1, wherein the apparatus is further configured to initializing an iterative haptic signal mediation loop for a scene within an application comprising:
generating an initial haptic data object for respective haptic objects of one or more haptic objects in a scene, wherein the initial haptic data object has attributes including a priority score and a dynamic sphere of influence; and
adding the initial haptic data object to a priority queue based on the priority score.

3. The apparatus of claim 1, wherein the initial haptic data object represents a single entity with a virtual environment that is able to generate haptic feedback.

4. The apparatus of claim 3, wherein the initial haptic data object encapsulates data and behavior related to one or more haptic object's physical properties, its priority, and its visual representation within a simulation.

5. The apparatus of claim 1, wherein the initial haptic data objects in the priority queue are retrieved from highest priority to lowest priority, and wherein the highest priority corresponds to a lowest negative score.

6. The apparatus of claim 1, wherein the priority score is calculated based on a velocity factor, proximity factor, and base priority determined from a scene description.

7. The apparatus of claim 6, wherein the velocity factor is comprised of velocity towards the user.

8. The apparatus of claim 6, wherein the base priority used for the one or more haptic objects is at least one of a priority of a movie picture experts group (MPEG) haptics perception object, a priority of a MPEG haptics channel object, a priority of a MPEG haptics band object of a MPEG haptics bitstream, or a priority that is set based on a priority value used in a MPEG_scene_interactivity extension for a behavior parameter.

9. The apparatus of claim 1, wherein the dynamic sphere of influence is defined by a base radius around the haptic object.

10. The apparatus of claim 9, wherein the dynamic sphere of influence is object-type dependent.

11. The apparatus of claim 10, wherein object-type dependent dynamic sphere of influence comprises a dynamically adjusted radius.

12. The apparatus of claim 11, wherein the base radius serves as a multiplier for the dynamically adjusted radius.

13. The apparatus of claim 12, wherein the dynamically adjusted radius adjusted by an attenuation factor comprising
$$α = \sqrt{\frac{γ \cdot ρ}{Y \cdot Z}} + {β}_{dir} \cdot cos ( θ ) ,$$
wherein ρ is equal to a density of a medium, Y is equal to Young's Modulus (stiffness), Z is equal to an impedance, γ is equal to a damping coefficient, βdir is equal to a directional attenuation constant for the medium, and θ is equal to an angle of energy propagation relative to a medium's primary axis.

14. An apparatus for real-time spatial haptic rendering in a multi-user environment, comprising:
at least one processor; and
at least one memory storing instructions that, when executed by the at least one processor, cause the apparatus to:
obtain haptic interaction points from a plurality of users;
process one or more initial haptic data objects for each one of the plurality of users, wherein each of the one or more initial haptic data objects includes a priority score and a dynamic sphere of influence;
manage the one or more initial haptic data objects using a priority queue implemented using a data structure selected from a group consisting of a heap, a balanced binary tree, a skip list, and a sorted array;
cull the one or more initial haptic data objects based on a distance function relative to each user's interaction point and a dynamic sphere of influence defined by alternative geometric configurations; and
generate updated scene representations for each user concurrently.

15. The apparatus of claim 14, wherein the dynamic sphere of influence is defined using one or more geometric configurations selected from a group consisting of a sphere, ellipsoid, cuboid, and cylindrical volume.

16. The apparatus of claim 15, wherein the one or more geometric configurations are dynamic adjustments.

17. The apparatus of claim 16, wherein the dynamic adjustments include dynamically varying dimensions of the geometric configuration based on an object type and an attenuation factor.

18. The apparatus of claim 14, wherein the apparatus is further configured to synchronize haptic rendering across the plurality of users by periodically aligning spatial coordinate frames and interaction timestamps to ensure consistent haptic feedback across the multi-user environment.

19. A method for real-time spatial haptic rendering comprising:
obtaining a user's haptic interaction point;
processing one or more initial haptic data objects wherein processing one of the initial haptic data object comprises:
retrieving an initial haptic data object from a priority queue; and
determining a distance between the user's haptic interaction point and the initial haptic data object,
wherein, in an instance in which the distance is outside of a dynamic sphere of influence for the initial haptic data object or in which the distance is increasing at a rate greater than a threshold rate, the haptic object is culled,
wherein, in an instance where the distance is within the dynamic sphere of influence for the initial haptic data object, a priority score of the initial haptic data object is updated with an updated priority score and updated in the priority queue; and
generating a user representation for an updated scene.

20. A method for real-time spatial haptic rendering in a multi-user environment, comprising:
obtaining haptic interaction points from a plurality of users;
processing one or more initial haptic data objects for each one of the plurality of users, wherein each of the one or more initial haptic data objects includes a priority score and a dynamic sphere of influence;
managing the one or more initial haptic data objects using a priority queue implemented using a data structure selected from a group consisting of a heap, a balanced binary tree, a skip list, and a sorted array;
culling the one or more initial haptic data objects based on a distance function relative to each user's interaction point and a dynamic sphere of influence defined by alternative geometric configurations; and
generating updated scene representations for each user concurrently.
